(19) United States
(12) Patent Application Publication
(10) Pub. No.: US 2017/0222763 A1
(43) Pub. Date: Aug. 3, 2017

(54) METHOD FOR MANAGING SOFT BUFFER IN WIRELESS COMMUNICATION SYSTEM AND APPARATUS FOR PERFORMING SAME

(71) Applicant: LG ELECTRONICS INC., Seoul (KR)

(72) Inventors: Seungmin LEE, Seoul (KR); Suckchel YANG, Seoul (KR); Joonkui AHN, Seoul (KR); Yunjung YI, Seoul (KR); Daesung HWANG, Seoul (KR)

(73) Assignee: LG ELECTRONICS INC., Seoul (KR)

(21) Appl. No.: 15/515,106

(22) PCT Filed: Oct. 2, 2015
(86) PCT No.: PCT/KR2015/010458

§ 371 Date: Mar. 28, 2017

Related U.S. Application Data
(60) Provisional application No. 62/059,865, filed on Oct. 4, 2014.
(60) Provisional application No. 62/106,748, filed on Jan. 23, 2015.
(60) Provisional application No. 62/112,731, filed on Feb. 6, 2015.
(60) Provisional application No. 62/232,432, filed on Sep. 24, 2015.

(51) Int. Cl. H04L 1/18; H04W 72/04; H04W 16/14

(52) U.S. Cl. CPC H04L 1/1835; H04L 1/1812; H04W 16/14; H04W 72/042; H04W 84/042

(57) ABSTRACT

A method for managing a soft buffer by a terminal in which a plurality of cells are set, in accordance with one embodiment of the present invention, comprises the steps of: receiving, from a base station, at least one parameter for allocation of the soft buffer; and allocating the soft buffer to the plurality of cells on the basis of the at least one parameter, wherein the soft buffer is divided unequally on the basis of the received at least one parameter, and at least one of the divided areas of the unequally divided soft buffer is shared by at least two cells among the plurality of cells.

### TECHNICAL FIELD

The present invention relates to a wireless communication system, and more particularly, to a method of managing a soft buffer in wireless communication environment in which a plurality of cells are configured and an apparatus therefor.

### BACKGROUND ART

A 3rd generation partnership project long term evolution (3GPP LTE) (hereinafter, referred to as ‘LTE’) communication system which is an example of a wireless communication system to which the present invention can be applied will be described in brief

FIG. 1 is a diagram illustrating a network structure of an Evolved Universal Mobile Telecommunications System (E-UMTS) which is an example of a wireless communication system. The E-UMTS is an evolved version of the conventional UMTS, and its basic standardization is in progress under the 3rd Generation Partnership Project (3GPP). The E-UMTS may be referred to as a Long Term Evolution (LTE) system. Details of the technical specifications of the UMTS and E-UMTS may be understood with reference to Release 7 and Release 8 of “3rd Generation Partnership Project; Technical Specification Group Radio Access Network”.

Referring to FIG. 1, the E-UMTS includes a User Equipment (UE), base stations (eNode B; eNB), and an Access Gateway (AG) which is located at an end of a network (E-UTRAN) and connected to an external network. The base stations may simultaneously transmit multiple data streams for a broadcast service, a multicast service and/or a unicast service.

One or more cells exist for one base station. One cell is set to one of bandwidths of 1.44, 3, 5, 10, 15 and 20 MHz to provide a downlink or uplink transport service to several user equipments. Different cells may be set to provide different bandwidths. Also, one base station controls data transmission and reception for a plurality of user equipments. The base station transmits downlink (DL) scheduling information of downlink data to the corresponding user equipment to notify the corresponding user equipment of time and frequency domains to which data will be transmitted and information related to encoding, data size, and hybrid automatic repeat and request (HARQ). Also, the base station transmits uplink (UL) scheduling information of uplink data to the corresponding user equipment to notify the corresponding user equipment of time and frequency domains that can be used by the corresponding user equipment, and information related to encoding, data size, and HARQ. An interface for transmitting user traffic or control traffic may be used between the base stations. A Core Network (CN) may include the AG and a network node or the like for user registration of the user equipment. The AG manages mobility of the user equipment on a Tracking Area (TA) basis, wherein one TA includes a plurality of cells.

Although the wireless communication technology developed based on WCDMA has been evolved into LTE, request and expectation of users and providers have continued to increase. Also, since another wireless access technology is being continuously developed, new evolution of the wireless communication technology will be required for competitiveness in the future. In this respect, reduction of cost per bit, increase of available service, use of adaptable frequency band, simple structure and open type interface, proper power consumption of the user equipment, etc. are required.

### DISCLOSURE OF THE INVENTION

### Technical Task

A technical task of the present invention is to provide a method of efficiently managing a soft buffer in wireless communication environment in which a plurality of cells are configured and an apparatus therefor.

It will be appreciated by persons skilled in the art that the objects that could be achieved with the present invention are not limited to what has been particularly described hereinabove and the above and other objects that the present invention could achieve will be more clearly understood from the following detailed description.

### Technical Solution

To achieve these and other advantages and in accordance with the purpose of the present invention, as embodied and broadly described, according to one embodiment, a method of managing a soft buffer, which is managed by a user equipment configured with a plurality of cells, includes receiving at least one parameter for allocating the soft buffer from a base station, and allocating the soft buffer to the plurality of cells based on the at least one parameter. In this case, the soft buffer is unequally allocated based on the at least one received parameter and at least one of partitions of the unequally divided soft buffer can be shared by at least two cells among the plurality of cells.

To further achieve these and other advantages and in accordance with the purpose of the present invention, according to a different embodiment, a user equipment configured with a plurality of cells includes a receiver configured to receive at least one parameter for allocating a soft buffer from a base station, and a processor configured to allocate the soft buffer to the plurality of cells based on the at least one parameter. In this case, the soft buffer is unequally allocated based on the at least one received parameter and at least one of partitions of the unequally divided soft buffer can be shared by at least two cells among the plurality of cells.

Preferably, the number of the partitions of the unequally divided soft buffer can be configured in a manner of being different from the number of the plurality of cells.

Preferably, the at least two cells sharing the partition can be determined according to whether or not the at least two cells are positioned at an unlicensed band.

Preferably, if the at least two cells compete with each other in the at least one shared partition, a licensed band cell may have priority over an unlicensed band cell among the at least two cells, a cell of a lower cell index may have priority among the at least two cells, or a cell of a lower downlink hybrid automatic repeat request (HARQ) process index may have priority among the at least two cells.

Preferably, the UE can hierarchically perform division of the soft buffer for a plurality of cell groups and re-division of the soft buffer for individual cells in each of the plurality of cell groups.

More preferably, a part of the soft buffer allocated to a licensed band cell group can be configured to be bigger than a remaining part of soft buffer allocated to an unlicensed band cell group among the plurality of cell groups.

More preferably, in a licensed band cell group among the plurality of cell groups, the re-division of the soft buffer for the individual cells may be performed based on a number of licensed band cells. In an unlicensed band cell group among the plurality of cell groups, the re-division of the soft buffer for the individual cells may be performed based on at least one of a number of unlicensed band cells, a maximum value of downlink hybrid automatic repeat request (HARQ) processes for each of the unlicensed band cells, and a maximum value of an reserved resource period (RRP) for each of the unlicensed band cells.

Preferably, the at least one parameter can include at least one of a number of virtual cells configured to be different from the number (N^{DL}_{Cell}) of the plurality of cells in dividing the soft buffer, a number (M_{DL}_{_}_{HARQ}) of cell-specifically configured maximum downlink hybrid automatic repeat request (HARQ) processes, a maximum number (Kc) of cells capable of being supported by the user equipment under a prescribed condition, a limit value (Mₗᵢₘᵢₜ), which is cell-specifically configured for the number (M_{DL}_{_}_{HARQ}) of maximum downlink hybrid automatic repeat request (HARQ) processes, and a cell-specific parameter (K_{MIMO}) supporting multiple transport blocks (TBs) in multiple input multiple output (MIMO) transmission mode.

Preferably, a size of each of the partitions of the unequally divided soft buffer can be configured based on at least one of a number of maximum downlink hybrid automatic repeat request (HARQ) processes for each of the plurality of cells, frequency bands at which the plurality of cells are positioned, a maximum value of an reserved resource period (RRP) in an unlicensed band cell, a maximum value of downlink subframes capable of being continuously scheduled in the unlicensed band cell, and a ratio between the unlicensed band cell and a licensed band cell among the plurality of cells.

### Advantageous Effects

According to one embodiment of the present invention, since a soft buffer is allocated in consideration of characteristics of a plurality of cells in wireless communication environment in which a plurality of the cells are configured, it is able to efficiently use a size-limited soft buffer.

It will be appreciated by persons skilled in the art that that the effects achieved by the present invention are not limited to what has been particularly described hereinabove and other advantages of the present invention will be more clearly understood from the following detailed description.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a schematic diagram of E-UMTS network structure as one example of a wireless communication system;

FIG. 2 is a diagram illustrating structures of a control plane and a user plane of a radio interface protocol between a user equipment and E-UTRAN based on the 3GPP radio access network standard;

FIG. 3 is a diagram illustrating physical channels used in a 3GPP LTE system and a general method for transmitting a signal using the physical channels;

FIG. 4 is a diagram illustrating a structure of a radio frame used in an LTE system;

FIG. 5 is a diagram for an example of a resource grid for a downlink slot;

FIG. 6 is a diagram illustrating a structure of a downlink radio frame used in an LTE system;

FIG. 7 is a diagram illustrating a structure of an uplink subframe used in an LTE system;

FIG. 8 illustrates a UL HARQ operation in LTE system;

FIG. 9 is a diagram for explaining FDD system and DL/UL HARQ timeline;

FIG. 10 illustrates scheduling in a case that a plurality of carriers are aggregated;

FIG. 11 illustrates a UL HARQ operation in LTE system;

FIG. 12 is a diagram for explaining FDD system and DL/UL HARQ timeline;

FIG. 13 is a diagram for an example of a method of using an unlicensed band;

FIGS. 14 and 15 are diagrams for examples of a method of occupying and using an unlicensed band;

FIG. 16 is a flowchart for a method of managing a soft buffer according to one embodiment of the present invention;

FIG. 17 illustrates a base station and a user equipment applicable to one embodiment of the present invention.

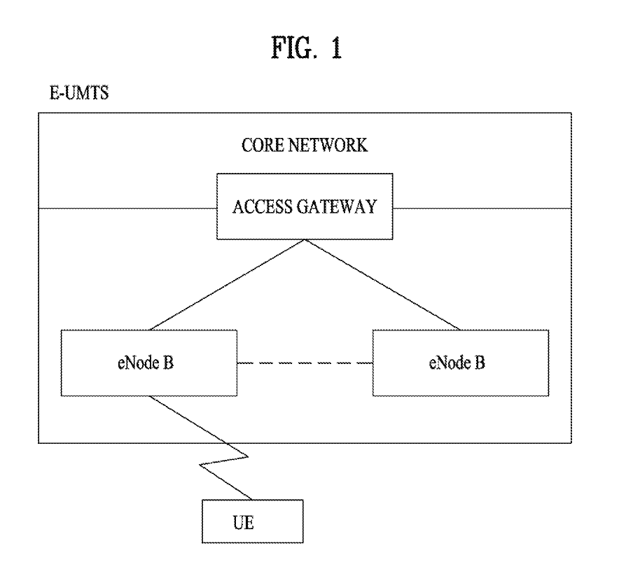

### BEST MODE

### Mode for Invention

The following technology may be used for various wireless access technologies such as CDMA (code division multiple access), FDMA (frequency division multiple access), TDMA (time division multiple access), OFDMA (orthogonal frequency division multiple access), and SC-FDMA (single carrier frequency division multiple access). The CDMA may be implemented by the radio technology such as UTRA (universal terrestrial radio access) or CDMA2000. The TDMA may be implemented by the radio technology such as global system for mobile communications (GSM)/general packet radio service (GPRS)/enhanced data rates for GSM evolution (EDGE). The OFDMA may be implemented by the radio technology such as IEEE 802.11 (Wi-Fi), IEEE 802.16 (WiMAX), IEEE 802.20, and evolved UTRA (E-UTRA). The UTRA is a part of a universal mobile telecommunications system (UMTS). A 3rd generation partnership project long term evolution (3GPP LTE) is a part of an evolved UMTS (E-UMTS) that uses E-UTRA, and adopts OFDMA in a downlink and SC-FDMA in an uplink. LTE-advanced (LTE-A) is an evolved version of the 3GPP LTE.

For clarification of the description, although the following embodiments will be described based on the 3GPP LTE/LTE-A, it is to be understood that the technical spirits of the present invention are not limited to the 3GPP LTE/LTE-A. Also, specific terminologies hereinafter used in the embodiments of the present invention are provided to assist understanding of the present invention, and various modifications may be made in the specific terminologies within the range that they do not depart from technical spirits of the present invention.

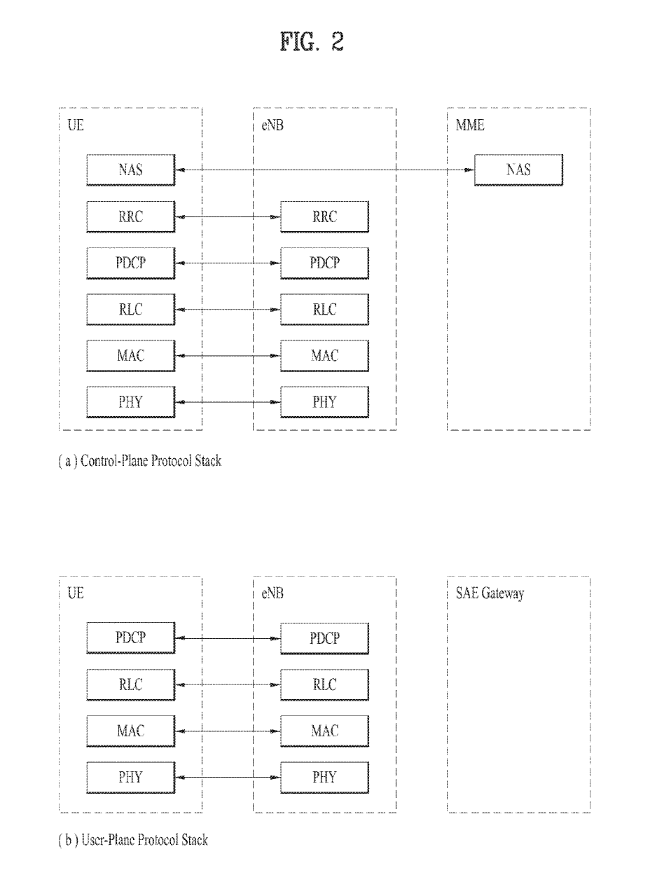

FIG. 2 is a diagram illustrating structures of a control plane and a user plane of a radio interface protocol between a user equipment and E-UTRAN based on the 3GPP radio access network standard. The control plane means a passageway where control messages are transmitted, wherein the control messages are used by the user equipment and the network to manage call. The user plane means a passageway where data generated in an application layer, for example, voice data or Internet packet data are transmitted.

A physical layer as the first layer provides an information transfer service to an upper layer using a physical channel. The physical layer is connected to a medium access control (MAC) layer via a transport channel, wherein the medium access control layer is located above the physical layer. Data are transferred between the medium access control layer and the physical layer via the transport channel. Data are transferred between one physical layer of a transmitting side and the other physical layer of a receiving side via the physical channel. The physical channel uses time and frequency as radio resources. In more detail, the physical channel is modulated in accordance with an orthogonal frequency division multiple access (OFDMA) scheme in a downlink, and is modulated in accordance with a single carrier frequency division multiple access (SC-FDMA) scheme in an uplink.

A medium access control (MAC) layer of the second layer provides a service to a radio link control (RLC) layer above the MAC layer via a logical channel. The RLC layer of the second layer supports reliable data transmission. The RLC layer may be implemented as a functional block inside the MAC layer. In order to effectively transmit data using IP packets such as IPv4 or IPv6 within a radio interface having a narrow bandwidth, a packet data convergence protocol (PDCP) layer of the second layer performs header compression to reduce the size of unnecessary control information.

A radio resource control (RRC) layer located on the lowest part of the third layer is defined in the control plane only. The RRC layer is associated with configuration, re-configuration and release of radio bearers (‘RBs’) to be in charge of controlling the logical, transport and physical channels. In this case, the RB means a service provided by the second layer for the data transfer between the user equipment and the network. To this end, the RRC layers of the user equipment and the network exchange RRC message with each other. If the RRC layer of the user equipment is RRC connected with the RRC layer of the network, the user equipment is in an RRC connected mode. If not so, the user equipment is in an RRC idle mode. A non-access stratum (NAS) layer located above the RRC layer performs functions such as session management and mobility management.

One cell constituting a base station eNB is set to one of bandwidths of 1.4, 3.5, 5, 10, 15, and 20 MHz and provides a downlink or uplink transmission service to several user equipments. At this time, different cells may be set to provide different bandwidths.

As downlink transport channels carrying data from the network to the user equipment, there are provided a broadcast channel (BCH) carrying system information, a paging channel (PCH) carrying paging message, and a downlink shared channel (SCH) carrying user traffic or control messages. Traffic or control messages of a downlink multicast or broadcast service may be transmitted via the downlink SCH or an additional downlink multicast channel (MCH). Meanwhile, as uplink transport channels carrying data from the user equipment to the network, there are provided a random access channel (RACH) carrying an initial control message and an uplink shared channel (UL-SCH) carrying user traffic or control message. As logical channels located above the transport channels and mapped with the transport channels, there are provided a broadcast control channel (BCCH), a paging control channel (PCCH), a common control channel (CCCH), a multicast control channel (MCCH), and a multicast traffic channel (MTCH).

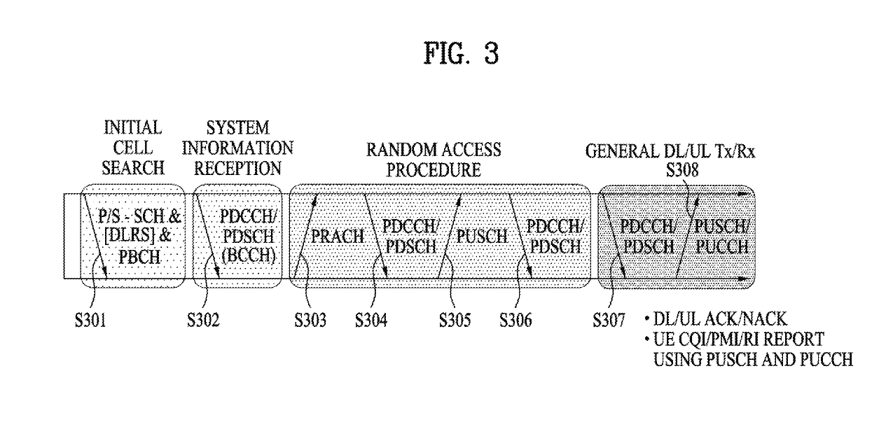

FIG. 3 is a diagram illustrating physical channels used in a 3GPP LTE system and a general method for transmitting a signal using the physical channels.

The user equipment performs initial cell search such as synchronizing with the base station when it newly enters a cell or the power is turned on at step S301. To this end, the user equipment synchronizes with the base station by receiving a primary synchronization channel (P-SCH) and a secondary synchronization channel (S-SCH) from the base station, and acquires information such as cell ID, etc. Afterwards, the user equipment may acquire broadcast information within the cell by receiving a physical broadcast channel (PBCH) from the base station. Meanwhile, the user equipment may identify a downlink channel status by receiving a downlink reference signal (DL RS) at the initial cell search step.

The user equipment which has finished the initial cell search may acquire more detailed system information by receiving a physical downlink shared channel (PDSCH) in accordance with a physical downlink control channel (PDCCH) and information carried in the PDCCH at step S302.

Afterwards, the user equipment may perform a random access procedure (RACH) such as steps S303 to S306 to complete access to the base station. To this end, the user equipment may transmit a preamble through a physical random access channel (PRACH) (S303), and may receive a response message to the preamble through the PDCCH and the PDSCH corresponding to the PDCCH (S304). In case of a contention based RACH, the user equipment may perform a contention resolution procedure such as transmission (S305) of additional physical random access channel and reception (S306) of the physical downlink control channel and the physical downlink shared channel corresponding to the physical downlink control channel.

The user equipment which has performed the aforementioned steps may receive the physical downlink control channel (PDCCH)/physical downlink shared channel (PDSCH) (S307) and transmit a physical uplink shared channel (PUSCH) and a physical uplink control channel (PUCCH) (S308), as a general procedure of transmitting uplink/downlink signals. Control information transmitted from the user equipment to the base station will be referred to as uplink control information (UCI). The UCI includes HARQ ACK/NACK (Hybrid Automatic Repeat and reQuest Acknowledgement/Negative-ACK), SR (Scheduling Request), CSI (Channel State Information), etc. In this specification, the HARQ ACK/NACK will be referred to as HARQ-ACK or ACK/NACK (A/N). The HARQ-ACK includes at least one of positive ACK (simply, referred to as ACK), negative ACK (NACK), DTX and NACK/DTX. The CSI includes CQI (Channel Quality Indicator), PMI (Precoding Matrix Indicator), RI (Rank Indication), etc. Although the UCI is generally transmitted through the PUCCH, it may be transmitted through the PUSCH if control information and traffic data should be transmitted at the same time. Also, the user equipment may non-periodically transmit the UCI through the PUSCH in accordance with request/command of the network.

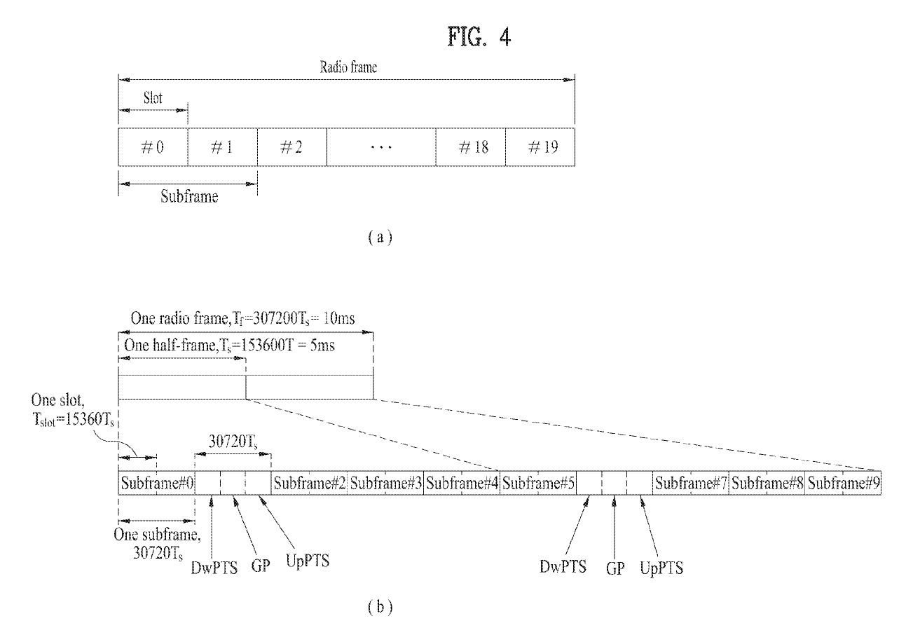

FIG. 4 is a diagram illustrating a structure of a radio frame used in an LTE system.

Referring to FIG. 4, in a cellular OFDM radio packet communication system, uplink/downlink data packet transmission is performed in a unit of subframe, wherein one subframe is defined by a given time interval that includes a plurality of OFDM symbols. The 3GPP LTE standard supports a type 1 radio frame structure applicable to frequency division duplex (FDD) and a type 2 radio frame structure applicable to time division duplex (TDD).

FIG. 4(a) is a diagram illustrating a structure of a type 1 radio frame. The downlink radio frame includes 10 subframes, each of which includes two slots in a time domain. A time required to transmit one subframe will be referred to as a transmission time interval (TTI). For example, one subframe may have a length of lms, and one slot may have a length of 0.5 ms. One slot includes a plurality of OFDM symbols in a time domain and a plurality of resource blocks (RB) in a frequency domain. Since the 3GPP LTE system uses OFDM in a downlink, OFDM symbols represent one symbol interval. The OFDM symbol may be referred to as SC-FDMA symbol or symbol interval. The resource block (RB) as a resource allocation unit may include a plurality of continuous subcarriers in one slot.

The number of OFDM symbols included in one slot may be varied depending on configuration of a cyclic prefix (CP). Examples of the CP include an extended CP and a normal CP. For example, if the OFDM symbols are configured by the normal CP, the number of OFDM symbols included in one slot may be 7. If the OFDM symbols are configured by the extended CP, since the length of one OFDM symbol is increased, the number of OFDM symbols included in one slot is smaller than that of OFDM symbols in case of the normal CP. For example, in case of the extended CP, the number of OFDM symbols included in one slot may be 6. If a channel state is unstable like the case where the user equipment moves at high speed, the extended CP may be used to reduce inter-symbol interference.

If the normal CP is used, since one slot includes seven OFDM symbols, one subframe includes 14 OFDM symbols. At this time, first maximum three OFDM symbols of each subframe may be allocated to a physical downlink control channel (PDCCH), and the other OFDM symbols may be allocated to a physical downlink shared channel (PDSCH).

FIG. 4(b) is a diagram illustrating a structure of a type 2 radio frame. The type 2 radio frame includes two half frames, each of which includes four general subframes, which include two slots, and a special subframe which includes a downlink pilot time slot (DwPTS), a guard period (GP), and an uplink pilot time slot (UpPTS).

In the special subframe, the DwPTS is used for initial cell search, synchronization or channel estimation at the user equipment. The UpPTS is used for channel estimation at the base station and uplink transmission synchronization of the user equipment. In other words, the DwPTS is used for downlink transmission, whereas the UpPTS is used for uplink transmission. Especially, the UpPTS is used for PRACH preamble or SRS transmission. Also, the guard period is to remove interference occurring in the uplink due to multipath delay of downlink signals between the uplink and the downlink.

Configuration of the special subframe is defined in the current 3GPP standard document as illustrated in Table 1 below. Table 1 illustrates the DwPTS and the UpPTS in case of Tₛ=1)15000×2048), and the other region is configured for the guard period.

TABLE 1

| | Normal cyclic prefix in downlink | | | Extended cyclic prefix in downlink | | |
|---|---|---|---|---|---|---|
| | | UpPTS | | | UpPTS | |
| Special | | Normal | Extended | | Normal | Extended |
| subframe | | cyclic prefix | cyclic prefix | | cyclic prefix | cyclic prefix |
| configuration | DwPTS | in uplink | in uplink | DwPTS | in uplink | in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | 12800 · Tₛ | | |
| 8 | 24144 · Tₛ | | | — | — | — |
| 9 | 13168 · Tₛ | | | — | — | — |

In the meantime, the structure of the type 2 radio frame, that is, uplink/downlink configuration (UL/DL configuration) in the TDD system is as illustrated in Table 2 below.

TABLE 2

| Uplink-downlink | Downlink-to-Uplink | Sunframe number | | | | | | | | | |
|---|---|---|---|---|---|---|---|---|---|---|---|
| configuration | Switch-point periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In the above Table 2, D means the downlink subframe, U means the uplink subframe, and S means the special subframe. Also, Table 2 also illustrates a downlink-uplink switching period in the uplink/downlink subframe configuration of each system.

TABLE 3

| UL-DL | Subframe n | | | | | | | | | |
|---|---|---|---|---|---|---|---|---|---|---|
| Configuration | 0 | 1 | 2 | 3 | 4 | 5 | 6 | 7 | 8 | 9 |
| 0 | — | — | 6 | — | 4 | — | — | 6 | — | 4 |
| 1 | — | — | 7, 6 | 4 | — | — | — | 7, 6 | 4 | — |
| 2 | — | — | 8, 7, 4, 6 | — | — | — | — | 8, 7, 4, 6 | — | — |
| 3 | — | — | 7, 6, 11 | 6, 5 | 5, 4 | — | — | — | — | — |
| 4 | — | — | 12, 8, 7, 11 | 6, 5, 4, 7 | — | — | — | — | — | — |
| 5 | — | — | 13, 12, 9, 8, 7, 5, 4, 11, 6 | — | — | — | — | — | — | — |
| 6 | — | — | 7 | 7 | 5 | — | — | 7 | 7 | — |

Table 3 illustrates UL ACK/NACK timeline. If a user equipment receives PDCCH and PDSCH scheduled by the PDCCH in a subframe #(n−k), it indicates that UL ACK/NACK is transmitted in a subframe #n in response to the received PDSCH.

And, the ACK/NACK for the PDSCH is transmitted on PUCCH corresponding to a UL control channel. In this case, information transmitted through the PUCCH may vary depending on a format. It is summarized as follows.

In LTE system, a PUCCH resource for ACK/NACK is not allocated to each UE in advance. Instead, a plurality of UEs belonging to a cell use a plurality of PUCCH resources by sharing the resources at every timing. Specifically, a PUCCH resource, which is used for a UE to transmit ACK/NACK, is implicitly determined based on PDCCH carrying scheduling information on PDSCH on which corresponding DL data is carried. In each DL subframe, the whole region to which PDCCH is transmitted consists of a plurality of CCEs (control channel elements) and PDCCH transmitted to a UE consists of one or more CCEs. A CCE includes a plurality of (e.g., 9) REGs (resource element groups). One REG includes 4 adjacent REs (resource elements) except a reference signal (RS). A UE transmits ACK/NACK via an implicit PUCCH resource which is induced or calculated by a function of a specific CCE index (e.g., first or lowest CCE index) among CCE indexes constructing the PDCCH received by the UE.

In this case, each PUCCH resource index corresponds to a PUCCH resource for ACK/NACK. For example, if scheduling information on PDSCH is transmitted to a UE via PDCCH configured by CCE indexes 4 to 6, the UE can transmit ACK/NACK to a BS via PUCCH, e.g., fourth PUCCH, induced or calculated from a 4^{th} CCE index corresponding to the lowest CCE index among the CCEs constructing the PDCCH.

PUCCH format 1a/2b transmits A/N information, PUCCH format 2/2a/2b transmits CQI, CQI+A/N information, and PUCCH format 3 can transmit multiple A/N information.

The structure of the aforementioned radio frame is only exemplary, and various modifications may be made in the number of subframes included in the radio frame, the number of slots included in the subframe, or the number of symbols included in the slot.

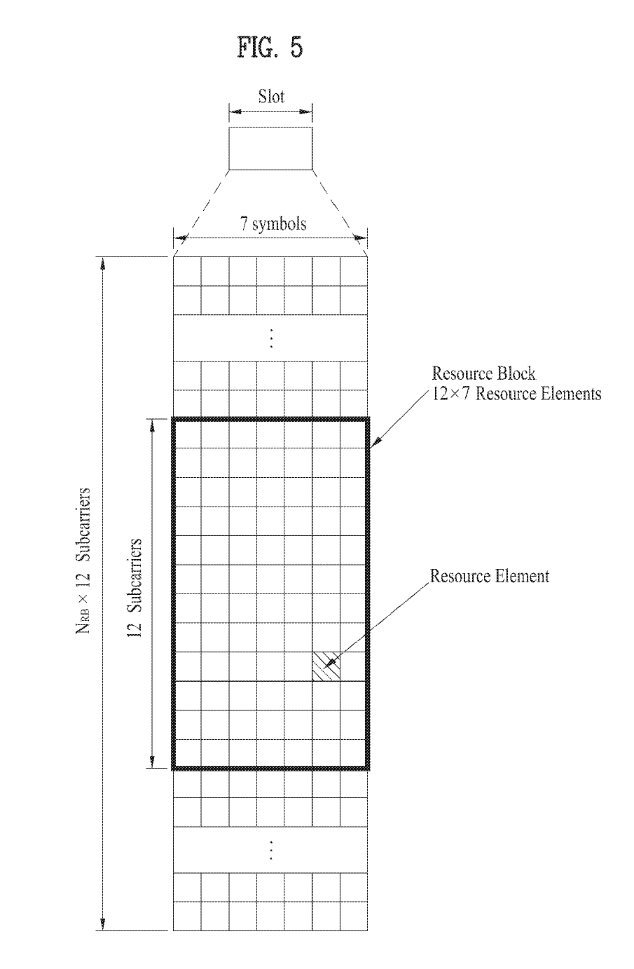

FIG. 5 is a diagram of a resource grid for a downlink slot.

Referring to FIG. 5, a DL slot includes N_{symb}^{DL} OFDM symbols in time domain and N_{RB}^{DL} resource blocks. Since each of the resource blocks includes N_{SC}^{RB} subcarriers, the DL slot includes N_{RB}^{DL}×N_{SC}^{RB} subcarriers in frequency domain. FIG. 5 shows one example that the DL slot includes 7 OFDM symbols and that the resource block includes 12 subcarriers, by which the present invention is non-limited. For instance, the number of OFDM symbols included in the DL slot can be modified according to a length of a cyclic prefix (CP).

Each element on a resource grid is called Resource Element (RE) and 1 single resource element is indicated by a single OFDM symbol index and a single subcarrier index. A single RB is configured with N_{symb}^{DL}×N_{SC}^{RB} resource elements. The number N_{RB}^{DL} of resource blocks included in the DL slot is dependent on a DL transmission bandwidth configured in a cell.

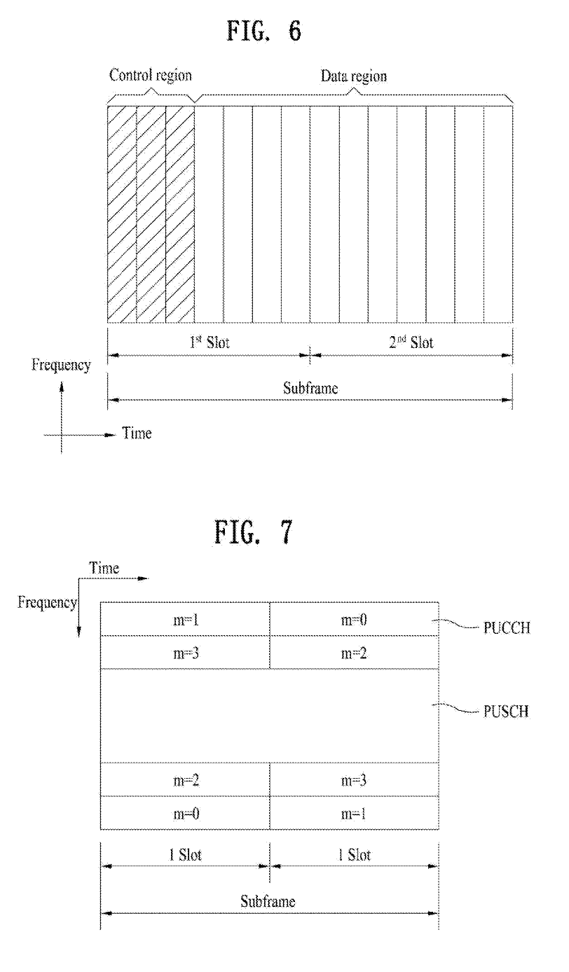

FIG. 6 is a diagram illustrating a structure of a downlink subframe.

Referring to FIG. 6, maximum three (four) OFDM symbols located at the front of the first slot of the subframe correspond to a control region to which a control channel is allocated. The other OFDM symbols correspond to a data region to which a physical downlink shared channel (PDSCH) is allocated. Examples of downlink control channels used in the LTE system include a Physical Control Format Indicator Channel (PCFICH), a Physical Downlink Control Channel (PDCCH), and a Physical Hybrid ARQ Indicator Channel (PHICH). The PCFICH is transmitted from the first OFDM symbol of the subframe, and carries information on the number of OFDM symbols used for transmission of the control channel within the subframe. The PHICH carries HARQ ACK/NACK (Hybrid Automatic Repeat reQuest acknowledgement/negative-acknowledgement) signals in response to uplink transmission.

The control information transmitted through the PDCCH will be referred to as downlink control information (DCI). The DCI includes resource allocation information for a user equipment or user equipment group. For example, the DCI includes uplink/ downlink scheduling information, uplink transmission (Tx) power control command, etc.

The PDCCH may include transport format and resource allocation information of a downlink shared channel (DL-SCH), transport format and resource allocation information of an uplink shared channel (UL-SCH), paging information on a paging channel (PCH), system information on the DL-SCH, resource allocation information of upper layer control message such as random access response transmitted on the PDSCH, a set of transmission (Tx) power control commands of individual user equipments (UEs) within a random user equipment group, transmission (Tx) power control command, and activity indication information of voice over Internet protocol (VoIP). A plurality of PDCCHs may be transmitted within the control region. The user equipment may monitor the plurality of PDCCHs. The PDCCH is transmitted on aggregation of one or a plurality of continuous control channel elements (CCEs). The CCE is a logic allocation unit used to provide the PDCCH with a coding rate based on the status of a radio channel. The CCE corresponds to a plurality of resource element groups (REGs). The format of the PDCCH and the number of available bits of the PDCCH are determined depending on the number of CCEs. The base station determines a PDCCH format depending on the DCI which will be transmitted to the user equipment, and attaches cyclic redundancy check (CRC) to the control information. The CRC is masked with an identifier (for example, radio network temporary identifier (RNTI)) depending on usage of the PDCCH or owner of the PDCCH. For example, if the PDCCH is for a specific user equipment, the CRC may be masked with cell-RNTI (C-RNTI) of the corresponding user equipment. If the PDCCH is for a paging message, the CRC may be masked with a paging identifier (for example, paging-RNTI (P-RNTI)). If the PDCCH is for system information (in more detail, system information block (SIB)), the CRC may be masked with system information RNTI (SI-RNTI). If the PDCCH is for a random access response, the CRC may be masked with a random access RNTI (RA-RNTI).

FIG. 7 is a diagram for an example of a structure of an uplink subframe in LTE.

Referring to FIG. 7, an uplink subframe includes a plurality of slots (e.g., 2 slots). A slot can include the different number of SC-FDMA symbols depending on a CP length. An uplink subframe is divided into a data region and a control region in frequency domain. The data region includes PUSCH and is used for transmitting a data signal such as audio and the like. The control region includes PUCCH and is used for transmitting uplink control information (UCI). PUCCH includes an RP pair positioned at both ends of the data region in frequency axis and hops at a slot boundary.

PUCCH can be used for transmitting control information described in the following.
SR (scheduling request): Information used for requesting uplink UL-SCH resource. OOK (on-off keying) scheme is used to transmit the SR.
HARQ ACK/NACK: Response signal for a DL data packet on PDSCH. This information indicates whether or not a DL data packet is successfully received. ACK/NACK 1 bit is transmitted in response to a single DL codeword. ACK/NACK 2 bits are transmitted in response to two DL codewords.
CSI (channel state information): Feedback information on a DL channel. CSI includes a CQI (channel quality indicator) and multiple input multiple output (MIMO)-related feedback information includes an RI (rank indicator), a PMI (precoding matrix indicator), a PTI (precoding type indicator) and the like. 20 bits per subframe are used.

An amount of control information (UCI) capable of being transmitted by a user equipment in a subframe is dependent on the number of SC-FDMAs available for transmitting control information. The SC-FDMAs available for transmitting the control information correspond to the remaining SC-FDMA symbols except SC-FDMA symbols used for transmitting a reference signal in a subframe. In case of a subframe to which an SRS (sounding reference signal) is set, a last SC-FDMA symbol of a subframe is also excluded. A reference signal is used for coherent detection of PUCCH.

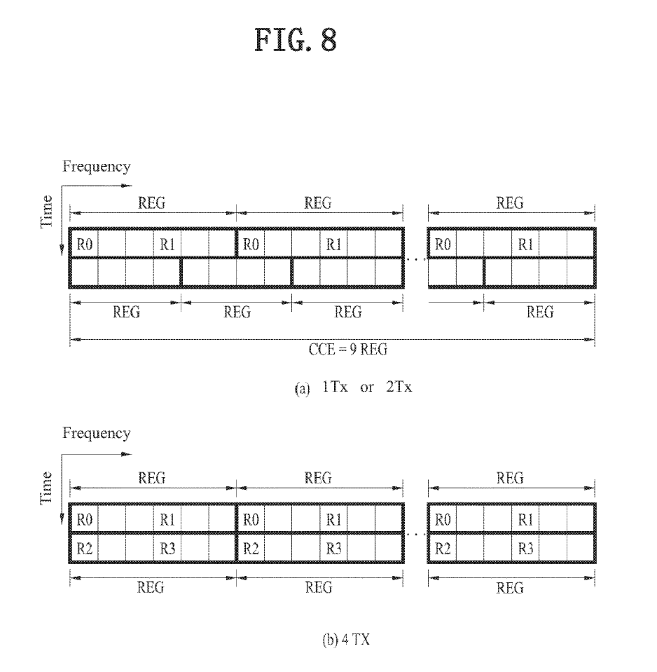

FIG. 8 is a diagram of a resource unit used for constructing a downlink control channel in LTE system. In particular, FIG. 8 (a) indicates a case that the number of transmitting antennas of an eNode B corresponds to 1 or 2 and FIG. 8 (b) indicates a case that the number of transmitting antennas of the eNode B corresponds to 4. A reference signal (RS) pattern varies according to the number of transmitting antennas but a method of configuring a resource unit in relation to a control channel is identical irrespective of the number of transmitting antennas.

Referring to FIG. 8, a base resource unit of a downlink control channel is a REG (resource element group). The REG consists of 4 neighboring resource elements except an RS. The REG is represented in the drawing with a bold line. The PCFICH and the PHICH include 4 REGs and 3 REGs, respectively. The PDCCH consists of a CCE (control channel element) unit and one CCE includes 9 REGs.

In order for a UE to check whether the PDCCH consisting of L number of CCEs is transmitted to the UE, the UE is configured to check the CCEs contiguously arranged by M^{(L)} (≧L) number of CCEs or a specific rule. A value of the L, which should be considered for the UE to receive the PDCCH, may become a plural number. The UE should check CCE aggregations to receive the PDCCH. The CCE aggregations are called a search space. As an example, the search space is defined by LTE system as Table 4 in the following.

TABLE 4

| Search space Sₖ^{(L)} | | | Number of PDCCH |
|---|---|---|---|
| Type | Aggregation level L | Size [in CCEs] | candidates M^{(L)} |
| UE- | 1 | 6 | 6 |
| specific | 2 | 12 | 6 |
| | 4 | 8 | 2 |
| | 8 | 16 | 2 |
| Common | 4 | 16 | 4 |
| | 8 | 16 | 2 |

In this case, CCE aggregation level L indicates the number of CCE consisting of PDCCH, Sₖ^{(L)} indicates a search space of the CCE aggregation level L and M^{(L)} indicates the number of candidate PDCCHs monitored in the search space of the aggregation level L.

The search space can be classified into a UE-specific search space accessible by a specific UE only and a common search space accessible by all UEs in a cell. A UE monitors the common search space of which the CCE aggregation level corresponds to 4 and 8 and monitors the UE-specific search space of which the CCE aggregation level corresponds to 1, 2, 4, and 8. The common search space and the UE-specific search space may overlap with each other.

And, a position of a first (having a smallest index) CCE in a PDCCH search space, which is given to a random UE for each CCE aggregation level value, varies in every subframe depending on a user equipment. This is called a PDCCH search space hashing.

The CCE can be distributed to a system band. More specifically, a plurality of CCEs, which are logically contiguous, can be inputted to an interleaver. The interleaver performs a function of mixing a plurality of the CCEs with each other in REG unit. Hence, frequency/time resources forming a CCE are physically distributed in the total frequency/time domain within a control region of a subframe. Consequently, although a control channel is constructed in a CCE unit, the interleaving is performed in an REG unit. Hence, frequency diversity and interference randomization gain can be maximized.

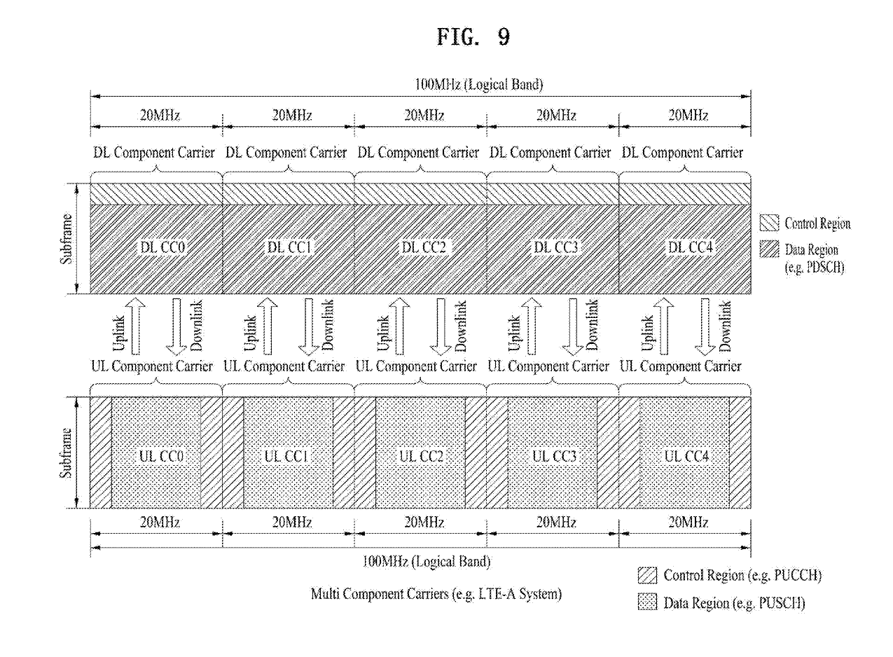

FIG. 9 is a diagram for an example of a carrier aggregation (CA) communication system.

Referring to FIG. 9, a wider UL/DL bandwidth can be supported in a manner of aggregating a plurality of UL/DL component carriers (CC). Such a term as a component carrier (CC) can be replaced with a different equivalent term (e.g., carrier, cell, etc.). Each of the component carriers may be adjacent to each other or non-adjacent to each other. The bandwidth of each of the component carriers can be determined independently. An asymmetric carrier aggregation, which means that the number of downlink component carrier (DL CC) and the number of uplink component carrier (UL CC) are different from each other, is also possible. Meanwhile, control information can be set to be transceived on a specific CC only. The specific CC is called a primary CC and the rest of CCs may be called a secondary CC.

If cross-carrier scheduling (or, cross-CC scheduling) is applied, PDCCH for DL allocation is transmitted via a DL CC #0 and corresponding PDSCH can be transmitted via a DL CC #2. For the cross-CC scheduling, it may consider introducing a CIF (carrier indicator field). A configuration informing whether a CIF exists or not within a PDCCH can be semi-statically and user-specifically (or user group-specifically) enabled via an upper layer signaling (e.g., RRC signaling).

In case that a CIF exists within a PDCCH, a base station may be able to assign a monitoring DL CC set to reduce BD complexity of a user equipment side. The PDCCH monitoring DL CC set corresponds to a part of the entire aggregated DL CCs and includes one or more DL CCs. A user equipment may be able to perform a detection/decoding of the PDCCH on a corresponding DL CC only. In particular, the base station may be able to transmit the PDCCH via the monitoring DL CC set only. The PDCCH monitoring DL CC set may be configured UE-specifically, UE group-specifically or cell-specifically. Such a term as PDCCH monitoring DL CC can be replaced with such an equivalent term as a monitoring carrier, a monitoring cell, and the like. And, CCs aggregated for a UE can be replaced with such an equivalent term as a serving CC, a serving carrier, a serving cell, and the like.

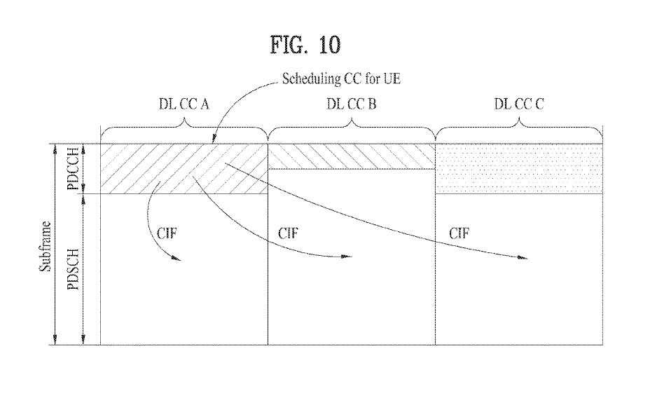

FIG. 10 is a diagram for an example of a case that 3 DL CCs are aggregated and a DL CC A is configured as a monitoring DL CC. DL CCs A to C can be referred to as a serving CC, a serving carrier, a serving cell, or the like. If a CIF is disabled, each of DL CCs may be able to transmit PDCCH, which schedules PDSCH of each of the DL CCs, without a CIF according to an LTE PDCCH rule. On the other hand, if the CIF is enabled by UE-specific (UE group-specific or cell-specific) upper layer signaling, only the DL CC A (monitoring DL CC) may be able to transmit the PDCCH, which schedules the PDSCH of a different DL CC as well as the PDSCH of the DL CC A using the CIF. In this case, PDCCH is not transmitted on a DL CC B and a DL CC C, which are not configured as a PDCCH monitoring DL CC. Hence, the DL CC A (monitoring DL CC) should include a PDCCH search space related to the DL CC A, a PDCCH search space related to the DL CC B, and a PDCCH search space related to the DL CC C. In the present specification, assume that a PDCCH search space is defined according to a carrier.

As mentioned in the foregoing description, LTE-A considers using a CIF in PDCCH to perform cross-CC scheduling. Whether or not a CIF is used (i.e., whether or not cross-CC scheduling mode or non-cross-CC scheduling mode is supported) and switching between modes can be semi-statically or UE-specifically configured via RRC signaling. After the RRC signaling is performed, a UE is able to recognize whether or not a CIF is used within PDCCH to be scheduled to the UE.

In the following, a HARQ (hybrid automatic repeat and request) in a wireless communication system is explained.

When there exist a plurality of UEs having data to be transmitted in UL/DL in a wireless communication system, a base station selects a UE to transmit the data from among a plurality of the UEs at every transmission unit time (transmission time interval (TTI) (e.g., subframe)). In particular, in a system using multiple carriers or a system similar to the system, the base station selects not only UEs to transmit data in UL/DL at every TTI but also a frequency band to be used by each of the selected UEs to transmit the data.

On the basis of UL, if the UEs transmit a reference signal (or pilot signal) to the base station in UL, the base station identifies channel states of the UEs using the reference signal received from the UEs and selects UEs to transmit data in UL on each unit frequency band at every TTI. The base station informs the UEs of a result of the selection. In particular, the base station transmits a UL assignment message to a UE UL scheduled at specific TTI to indicate the UE to transmit data using a specific frequency band. The UL assignment message is also referred to as a UL grant. The UE transmits the data in UL according to the UL assignment message. Basically, the UL assignment message includes information on a UE ID (UE identity), RB allocation information, payload, etc. In addition, the UL assignment message can include an IR (incremental redundancy) version, NDI (new data indication), and the like.

In case of using a synchronous non-adaptive HARQ scheme, when a UE scheduled at specific time performs retransmission, retransmission time is systematically promised between the UE and the base station (e.g., after 4 subframes from the timing at which NACK is received). Hence, the base station can transmit the UL grant message to the UE at the initial transmission only and the retransmission can be performed by ACK/NACK signal. On the contrary, in case of using an asynchronous adaptive HARQ scheme, since retransmission time is not promised between the base station and the UE, it is necessary for the base station to transmit a retransmission request message to the UE. Moreover, since a frequency resource for retransmission or MCS varies depending on transmission timing, the base station should transmit not only a UE ID, RB allocation information, and payload but also a HARQ process index, IR version, and NDI information to the UE at the time of transmitting the retransmission request message to the UE.

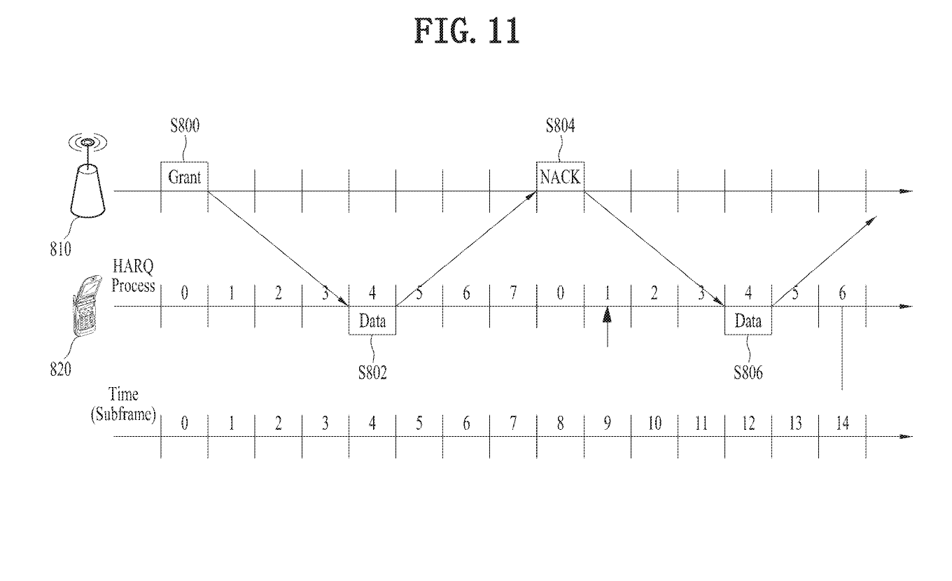

FIG. 11 illustrates a UL HARQ operation in LTE system. In LTE system, a UL HARQ scheme uses synchronous non-adaptive HARQ. In case of using 8-channel HARQ, HARQ process numbers are given by 0 to 7. One HARQ process operates at every TTI (e.g., subframe). Referring to FIG. 11, a base station 810 transmits a UL grant to a UE 820 through PDCCH [S800]. The UE transmits UL data to the base station 810 using an RB designated by the UL grant and MCS after 4 subframes (e.g., subframe #4) from the timing (e.g., subframe #0) at which the UL grant is received [S802]. After the UL data received from the UE 820 is decoded, the base station 810 generates ACK/NACK. If the base station fails to decode the UL data, the base station 810 transmits NACK to the UE 820 [S804]. The UE 820 retransmits UL data to the base station after 4 subframes from the timing at which the NACK is received [S806]. In this case, the initial transmission and the retransmission of the UL data are performed by the same HARQ process (e.g., HARQ process 4).

In the following, DL/UL HARQ operation in FDD system is explained.

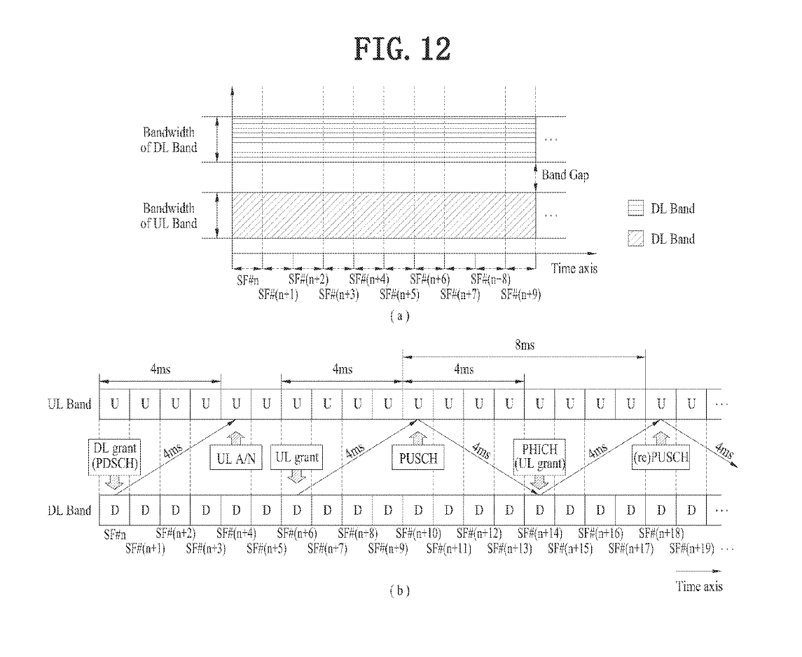

FIG. 12 is a diagram for explaining a FDD system and a DL/UL HARQ timeline. In case of the FDD system illustrated in FIG. 12 (a), transmission/reception of a DL/UL data corresponding to a specific UL/DL data is received after 4 ms. Referring to FIG. 12 (b), for example, UL ACK/NACK is transmitted after 4 ms from the timing at which PDSCH/DL grant is received in response to the PDSCH, PUSCH is transmitted after 4 ms from the timing at which UL grant/PHICH is received in response to the UL grant/PHICH, and PHICH/UL grant is received after 4 ms from the timing at which PUSCH is transmitted/retransmitted in response to the PUSCH transmission/retransmission.

And, a synchronous HARQ scheme is used for a UL HARQ operation and an asynchronous HARQ scheme is used for a DL HARQ operation in 3GPP LTE system. The synchronous HARQ scheme corresponds to a scheme that retransmission is performed at a timing determined by a system when initial transmission fails. In particular, transmission/retransmission of UL data interlocked with a specific HARQ process or timing associated with a UL grant/PHICH timeline is defined in advance and it is difficult to randomly change the transmission/retransmission or the timing. On the contrary, according to the asynchronous HARQ scheme, when an initial transmission of data fails, retransmission of the data can be performed at a random timing appearing after 8 ms including the initial transmission timing.

In the aforementioned FIGS. 11 and 12, each of the HARQ processes is defined by a unique HARQ process identifier having a size of 3 bits and it is necessary for a receiving end (i.e., a UE in a DL HARQ process, an eNB in a UL HARQ process) to allocate an individual soft buffer to combine retransmitted data.

In the following, HARQ timing in environment in which a TDD cell and a FDD cell are aggregated is explained. For example, assume that a TDD Pcell and a FD Scell are aggregated by CA (carrier aggregation). If a UE apply DL timing (e.g., 4 ms) defined for legacy FDD to PDSCH received via the FDD Scell as it is, since the TDD Pcell is configured by a DL subframe at the DL HARQ timing, it may be difficult to transmit ACK/NACK. Hence, when the TDD cell and the FDD cell are aggregated, it may define new DL HARQ timing and new UL HARQ timing. Examples of the new DL HARQ timing and the new UL HARQ timing are described in the following.

DL HARQ timing for TDD Scell, in case of FDD Pcell

In case of performing self-scheduling and cross carrier scheduling, HARQ timing for PDSCH of the TDD Scell can be configured to be identical to HARQ timing for the FDD Pcell. For example, ACK/NACK information on PDSCH of the Scell can be transmitted via the Pcell.

UL HARQ timing for TDD Scell, in case of FDD Pcell
Self-scheduling: HARQ timing for PUSCH transmitted via the Scell can be configured based on HARQ timing scheduled to the TDD cell.
Cross carrier scheduling: (i) Similar to the self-scheduling, HARQ timing for PUSCH transmitted via the Scell can be configured based on HARQ timing scheduled to the TDD cell. (ii) Or, ACK/NACK information can be received via PHICH after 6 ms from timing at which PUSCH is transmitted via the Scell. (iii) Or, HARQ timing can be configured based on reference UL-DL configuration obtained by a scheduling cell.

DL HARQ timing for FDD Scell, in case of TDD Pcell
Self-scheduling: (i) HARQ timing for PDSCH of the Scell can be configured by additional timing different from HARQ timing of the TDD Pcell and HARQ timing of the TDD Pcell based on UL-DL configuration of the TDD Pcell. Or, It may define new timing including more DL subframes than the legacy TDD Pcell HARQ timing according to UL-DL configuration of the TDD Pcell. For details, it may refer to Table 5 in the following. (ii) Or, HARQ timing for PDSCH of the Scell can be determined based on reference UL-DL configuration set to the FDD Scell. The reference UL-DL configuration can be determined based on UL-DL configuration of the TDD Pcell. And, it may configure additional HARQ timings different from the HARQ timing of the TDD Pcell. For more details, it may refer to Tables 6, 7, and 8 in the following.
Cross carrier scheduling: HARQ timing for PDSCH of the Scell can be configured to be identical to the self-scheduling or the HARQ timing of the TDD Pcell.

UL HARQ timing for FDD Scell, in case of TDD Pcell
Self scheduling: HARQ timing for PUSCH transmitted via the Scell can be configured by FDD HARQ timing.
Cross carrier scheduling: (i) HARQ timing for PUSCH transmitted via the Scell may follow HARQ timing of the TDD Pcell or FDD HARQ timing. (ii) Or, as an example, ACK/NACK information can be received via PHICH after 6 ms from timing at which PUSCH is transmitted via the Scell. Unlikely, it may configure by FDD HARQ timing.

Table 5 corresponds to a TDD Pcell case and shows detail examples of (i) the self-scheduling case of the DL HARQ timing (e.g., ‘DL association set index’) for the FDD Scell.

TABLE 5

| UL-DL | HARQ | Subframe n | | | | | | | | | |
|---|---|---|---|---|---|---|---|---|---|---|---|
| Conf. | timing | 0 | 1 | 2 | 3 | 4 | 5 | 6 | 7 | 8 | 9 |
| 0 | 0A | — | — | 6, [5] | [5], [4] | 4 | — | — | 6, [5] | [5], [4] | 4 |
| 0 | 0B | | | 6, [5], [4] | | [5], 4 | | | 6, [5], [4] | | [5], [4] |
| 1 | 1 | — | — | 7, 6, [5] | [5], [4] | — | — | — | 7, 6, [5] | [5], [4] | — |
| 1 | 1* | | | 7, 6 | [6], [5], [4] | | | | 7, 6 | [6], [5], [4] | |
| 2 | 2 | — | — | 8, 7, 6, [5], 4 | — | — | — | — | 8, 7, 6, [5], 4 | — | — |
| 3 | 3 | — | — | 11, [10], [9], [8], 7, 6 | 6, 5 | 5, 4 | — | — | — | — | — |
| 3 | 3a | — | — | 11, [10], 7, 6 | [10], 6, 5 | [10], 5, 4 | | | | | |
| 4 | 4 | — | — | 12, 11, [10], [9], 8, 7 | 7, 6, 5, 4 | | | | | | |
| 4 | 4a | | | 12, 11, [10], 8, 7 | [10], 7, 6, 5, 4 | | | | | | |
| 5 | 5 | — | — | 13, 12, 11, [10], 9, | — | — | — | — | — | — | — |
| | | | | 8, 7, 6, 5, 4 | | | | | | | |
| 6 | 6 | — | — | [8], 7 | 7, [6] | [6], [5] | — | — | 7 | 7, [6], [5] | — |
| 6 | 6* | — | — | 7 | 7, [6], [5] | 5 | — | — | 7, [6], [5], [4] | 7 | — |

In Table 5, UL-DL configuration may correspond to U/D configuration of the TDD Pcell. DL HARQ timing for the FDD Scell can be defined by a type/index of HARQ timing associated with the TDD Pcell U/D. ‘DL association set index’ may correspond to “[ ]” in Table 5. In particular, the “[ ]” may correspond to a DL association set index added to the TDD Pcell U/D configuration. For example, in case of UL-DL configuration 0 and HARQ timing 0A, a subframe #2 transmit ACK/NACK for PDSCH (i.e., subframe #6 of a previous frame) of the FDD Scell which is received 5 subframes ahead and ACK/NACK for PDSCH (i.e., subframe #7 of a previous frame) of the FDD Scell which is received 6 subframes ahead, respectively. A subframe #3 transmit ACK/NACK for PDSCH (i.e., subframe #8 of a previous frame) of the FDD Scell which is received 5 subframes ahead and ACK/NACK for PDSCH (i.e., subframe #9 of a previous frame) of the FDD Scell which is received 4 subframes ahead, respectively.

Tables 6, 7, and 8 correspond to a TDD Pcell case and shows detail examples of (ii) the self-scheduling case of the DL HARQ timing (e.g., ‘DL association set index’) for the FDD Scell.

TABLE 6

| TDD PCell | Allowed reference |
|---|---|
| U/D configuration | configuration for FDD SCell |
| 0 | {0, 1, 2, 3, 4, 5, 6,} |
| 1 | {1, 2, 4, 5} |
| 2 | {2, 5} |
| 3 | {3, 4, 5} |
| 4 | {4, 5} |
| 5 | {5} |
| 6 | {1, 2, 3, 4, 5, 6} |

TABLE 7

| TDD PCell | Allowed reference |
|---|---|
| U/D configuration | configuration for FDD SCell |
| 0 | {2, 4, 5} |
| 1 | {2, 4, 5} |
| 2 | {2, 5} |
| 3 | {4, 5} |
| 4 | {4, 5} |
| 5 | {5} |
| 6 | {2, 4, 5} |

TABLE 8

| TDD PCell | Allowed reference | Allowed reference |
|---|---|---|
| U/D | configuration for FDD SCell | configuration for FDD SCell |
| configuration | (2 aggregated cells) | (more than 2 aggregated cells) |
| 0 | 5 | 2 |
| 1 | 5 | 2 |
| 2 | 5 | 2 |
| 4 | 5 | 4 |
| 4 | 5 | 4 |
| 5 | 5 | Not applicable |
| 6 | 5 | 2 |

In the following, ACK/NACK multiplexing or bundling scheme is explained.

An ACK/NACK multiplexing (i.e., ACK/NACK selection) method applied to Rel-8 TDD system considers an ACK/NACK selection scheme that uses an implicit PUCCH resource corresponding (i.e., linked to a lowest CCE index) to PDCCH scheduling each PDSCH of a UE to secure a PUCCH resource of the UE.

Meanwhile, LTE-A FDD system basically considers transmitting a plurality of ACKs/NACKs in response to a plurality of PDSCHs, which are transmitted via a plurality of DL component carriers, through a UE-specifically configured specific UL CC. To this end, LTE-A FDD system considers “ACK/NACK selection” scheme using an implicit PUCCH resource linked with PDCCH that schedules a specific DL component carrier, a part of DL component carriers, or all DL component carriers (i.e., linked with a lowest CCE index nCCE, or nCCE and nCCE+1), or a combination of the implicit PUCCH resource and an explicit PUCCH resource reserved to each UE in advance via RRC signaling.

LTE-A TDD system can also consider a situation that pluralities of component carriers are aggregated. Hence, it may consider transmitting a plurality of ACK/NACK information/signals in response to a plurality of PDSCHs, which are transmitted via a plurality of DL subframes and a plurality of component carriers, in UL subframes corresponding to a plurality of the DL subframes via a specific CC (i.e., AN/CC). In this case, unlike the LTE-A FDD, it may consider a scheme of transmitting a plurality of ACKs/NACKs corresponding to the maximum number of CWs capable of being transmitted via all component carriers assigned to a UE to all of a plurality of DL subframes (i.e., full ACK/NACK) or a scheme of transmitting ACKs/NACKs by reducing the number of ACKS/NACKs by applying ACK/NACK bundling to CW and/or CC and/or SF domain (i.e., bundles ACK/NACK). In this case, in case of the CW bundling, ACK/NACK bundling for CW is applied to each DL subframe according to a component carrier. In case of the CC bundling, ACK/NACK bundling for all or a part of CCs is applied to each DL subframe. In case of the SF bundling, ACK/NACK bundling for all or a part of DL SFs is applied to each CC.

Meanwhile, LTE-A system considers transmitting a plurality of ACK/NACK information/signals for a plurality of PDSCHs, which are transmitted via a plurality of DL component carriers (DL CCs), via a specific UL component carrier (UL CC). In this case, unlike ACK/NACK transmission using a PUCCH format 1a/1b in legacy Rel-8 LTE, it may consider a method of transmitting a plurality of ACK/NACK information and/or control signals using a PUCCH format 2 or a PUCCH format 3 corresponding to a form modified based on block-spreading scheme after channel coding (e.g., Reed-Muller code, Tail-biting convolutional code, etc.) is performed on a plurality of the ACK/NACK information.

In this case, the block-spread scheme corresponds to a method of modulating control information (e.g., ACK/NACK, etc.) transmission using SC-FDMA scheme rather than a PUCCH format 1 or 2 of legacy LTE. According to the block-spread scheme, a symbol sequence can be transmitted in a manner of being spread in time domain by an OCC (orthogonal cover code). In this case, it may be able to multiplex control signals of a plurality of UEs with the same resource block (RB) using the OCC.

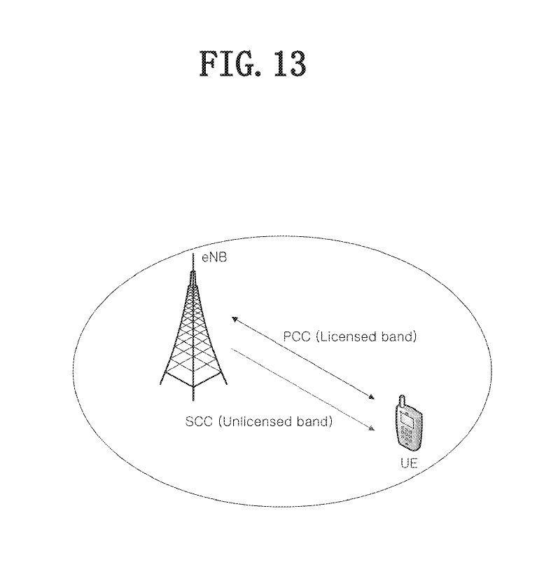

FIG. 13 is a diagram for an example of a method of using an unlicensed band.

For example, a licensed band may correspond to a frequency band that a communication service provider has secured the dominant use of the frequency band via such a procedure as auction or the like.

On the other hand, an unlicensed band corresponds to a band that the dominant use of the band is not secured. Hence, the great number of communication equipments can use the band without restriction. The unlicensed band can also be referred to as an ISM (industrial, scientific, medical) band. If a neighbor band protection rule equal to or greater than a prescribed level and interference-related rule are kept on the unlicensed band, the great number of communication equipments can use the unlicensed band without any restriction. As a result, it is difficult to secure communication quality of a level capable of being provided by a communication service via a licensed band of which the dominant use is guaranteed. More specifically, an unlicensed band corresponds to an internationally assigned frequency band for industrial, scientific, and medical purposes.

For example, 902 to 928 MHz band, 100 MHz band of 2.4 to 2.5 GHz at which wireless LAN service is activated, or 150 MHz band of 5.725 to 5.875 GHz may correspond to a representative unlicensed band. Yet, In Korea, 902 MHz band is not the ISM band.

2.4 GHz band has a merit in that the band has a wide bandwidth and a relatively low frequency. In most areas, 2.4 GHz band is defined as an unlicensed band. Hence, WLAN standards based on IEEE 802.11b/g/n are designed based on the 2.4 GHz band. Currently, many WLAN APs (access points) are installed on the 2.4 GHz band.

In case of 5 GHz band, a frequency resource of about 500 MHz bandwidth is allocated for the usage of unlicensed band in leading countries including the United States, Europe, and Korea. In the future, it is expected that bandwidths as much as maximum 195 MHz are to be additionally excavated depending on a country. Currently, 5 GHz band is getting most spotlights among unlicensed bands capable of being internationally worked together. Compared to 2.4 GHz band, 5.8 GHz band has a merit in that interference is low.

A cellular communication system according to one embodiment of the present invention can utilize 5 GHz unlicensed band or 2.4 GHz band used by WiFi system for traffic offloading.

Since an unlicensed band basically assumes that wireless transmission and reception are performed via contention between communication nodes, it is required for each communication node to perform channel sensing before a signal is transmitted to check a signal is not transmitted by a different communication node. The channel sensing is referred to as CCA (clear channel assessment) or carrier sensing. In LTE system, it is necessary for an eNB or a UE to perform the CCA to transmit a signal on an unlicensed band (hereinafter, LTE-U band).

For example, when the eNB or the UE transmits a signal, it is also necessary for other communication nodes such as WiFi and the like to perform the CCA to prevent interference. For example, in the Wi-Fi standard (e.g., 801.11ac), a CCA threshold is specified to be −62 dBm for non-Wi-Fi signals and −82 dBm for Wi-Fi signals. Accordingly, STA/AP does not perform signal transmission so as not to cause interference when a non-WiFi signal is received at a power greater than or equal to −62 dBm. In a Wi-Fi system, the STA or AP may perform CCA and signal transmission if a signal above a CCA threshold is not detected for more than 4 μs.

According to the embodiment of FIG. 13, an eNB may transmit a signal to a UE or the UE may transmit a signal to the eNB in a CA (carrier aggregation) situation of the LTE/LTE-A licensed band and the LTE-U unlicensed band.

For clarity, assume that a Pcell (PCC) is positioned at a licensed band and at least one of SCells (SCC) is positioned at an unlicensed band, by which the present invention may be non-limited. For example, a plurality of licensed bands and a plurality of unlicensed bands can be CA or a signal can be transceived between the eNB and the UE on an unlicensed band only. Moreover, the embodiments of the present invention can be extensively applied not only to 3GPP LTE/LTE-A system, but also to other wireless communication systems.

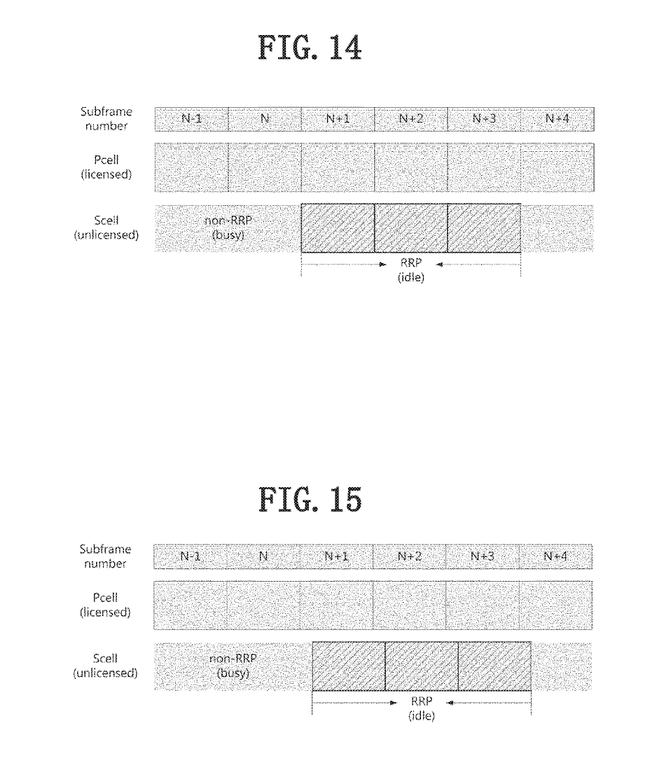

FIGS. 14 and 15 are diagrams for examples of a method of occupying and using an unlicensed band.

As mentioned in the foregoing description, in order to perform communication between an eNB and a UE in an LTE-U band, the LTE-U band should be occupied and secured for a specific time period through contention with other communication systems (e.g., Wi-Fi). For simplicity, a resource (/time) period aperiodically occupied/secured for communication in the LTE-U band is referred to as a reserved resource period (RRP).

There are various methods for securing the RRP. For example, a specific reservation signal may be transmitted such that other communication system devices such as Wi-Fi can recognize that the corresponding wireless channel is busy. For example, the eNB may continuously transmit a signal (e.g., RS and/or data) equal to greater than a prescribed power level during the RRP. The eNB may signal the UE of the predetermined RRP to allow the UE to maintain a link during the indicated RRP. For example, the eNB may signal RRP capable of being used by a CC of the LTE-U band via another carrier aggregated CC (e.g., LTE-A band).

As a different example of an unlicensed band operation operated by a contention-based random access scheme, the eNB can perform carrier sensing (CS) before data is transmitted and received. As a result of the CS, if a band at which an Scell is positioned is idle, the eNB can transmit a scheduling grant of the Scell, which is cross carrier scheduled via (E)PDCCH of the Pcell, or transmit a scheduling grant via PDCCH of self-scheduled Scell.

The RRP can be configured by M number of consecutive subframes. The eNB can signal the UE of M value and the usage of the M number of subframes via higher layer signaling (e.g., via Pcell) or a physical layer control/data channel.

The start timing of the RRP can be periodically configured via higher layer signaling or can be semi-statically configured. Or, the start timing of the RRP interval can be signaled at an SF #n or an SF #(n-k) appearing prior to the SF #n as many as k subframes via physical layer signaling.

According to the embodiment of FIG. 14, the RRP may be configured such that the SF boundary and the SF number/index thereof are aligned with the PCell (hereinafter, “aligned-RRP”), or configured such that the SF boundary or the SF number/index is not aligned with the PCell (hereinafter, “floating-RRP”). If an interval between a subframe of a first cell and a subframe of a second cell is equal to or less than prescribed time (e.g., CP length, or X usec where X≧0), it can be regarded as a subframe boundary between the first cell and the second cell is aligned.

Meanwhile, according to one embodiment, a reference cell used to determine a subframe boundary or a symbol boundary of the Scell of the LTE-U band (hereinafter, Ucell) can be defined as the Pcell in the aspect of time/frequency synchronization.

In the present invention, similar to the aforementioned LTE-U system opportunistically operating based on a CS (carrier sensing) operation on an unlicensed band, the present invention proposes methods of efficiently performing communication in a CA situation including a cell (carrier) that an available resource section is aperiodically or discontinuously secured/configured.

According to one embodiment, a control information channel for PDSCH/PUSCH, which is transmitted via a subframe within UCell RRP, can be transmitted via a PCell (i.e., cross carrier scheduling, CCS) or the UCell (i.e., self-scheduling, SFS).

According to a different embodiment, a control information channel for PDSCH, which is transmitted via a subframe within the UCell RRP, can be configured to schedule PDSCH which is received in a subframe identical to a subframe in which the control information is received (i.e., single subframe scheduling, SSFS) or can be configured to schedule PDSCHs received from a plurality of subframes at a time (i.e., multi subframe scheduling, MSFS). In case of the MSFS, the number of PDSCHs scheduled at a time can be defined in advance or can be signaled via higher layer signaling.

Since RRP on the UCell is aperiodically or discontinuously configured depending on a CS result, the RRP interval can be newly defined or interpreted in terms of a UE operation and assumption. As an example, the RRP on the UCell may correspond to a section that the UE performs time/frequency synchronization on the UCell, a section assumed as a synchronization signal for synchronization is transmitted (e.g., PSS, SSS from eNB), a section assumed as the UE performs CSI measurement on the UCell or a reference signal (e.g., CRS, CSI-RS from eNB) for measuring CSI is transmitted from an eNB, a section that the UE performs DCI detection on data transmission and reception in the UCell, or a section that the UE buffers a signal received in the UCell. The buffering can be temporarily performed.

In the following, similar to LTE-U system opportunistically operating based on CS (carrier sensing) operation on an unlicensed band, the present invention proposes methods of efficiently managing a soft buffer in a CA situation including a cell or a carrier that an available resource section is aperiodically or discontinuously secured/configured. And, as an example, in order to efficiently manage a soft buffer, the methods proposed by the present invention can be extensively applied to a situation that CA is performed on the relatively greater number of cells (e.g., 6 or more cells) (e.g., only LCells are configured by CA and/or only UCells are configured by CA and/or a combination of LCell and UCell is configured by CA).

First of all, a method of dividing a soft buffer in CS situation defined in 3GPP LTE-A system is explained with reference to Table 9.

TABLE 9
STORING SOFT CHANNEL BITS
For FDD, TDD and FDD-TDD; if the UE is configured with more than one serving cell, then for each serving
cell, for at least K_{MIMO} · min (M_{DL}_HARQ, Mₗᵢₘᵢₜ) transport blocks, upon decoding failure of a code block of
a transport block, the UE shall store received soft channel bits corresponding to a range of at least
wₖ wₖ₊₁, . . . , w_{mod(k+N}_{_{SB}}_{-1, N}_{_{cb}}₎, where:
${n}_{SB} = min ( {N}_{cb} , ⌊ \frac{{N}_{soft}^{′}}{C \cdot {N}_{cells}^{DL} \cdot {K}_{MIMO} \cdot min ( {M}_{DL\_HARQ} , {M}_{limit} )} ⌋ ) .$
wₖ, C, N_{cb}, K_{MIMO}′, and Mₗᵢₘᵢₜ are defined in subclause 5.1.4.1.2 of [2]. M_{DL}_HARQ is the maximum
number of DL HARQ processes. N_{cells}^{DL} is the number of configured serving cells.
If the UE signals ue-Category-v12x y, N_{soft}′ is the total number of soft channel bits [3] according to the UE
category indicated by ue-Category-v12xy [4]. Else if the UE signals ue-Category-v1170 and not ue-Category-
v12xy, N_{soft}′ is the total number of soft channel bits [3] according to the UE category indicated by ue-
Category-v1170 [4]. Else if the UE signals ue-Category-v1020 and not ue-Category-v1170 and not ue-
Category-v12xy, N_{soft}′ is the total number of soft channel bits [3] according to the UE category indicated by
ue-Category-v1020 [4]. Otherwise, N_{soft}′ is the total number of soft channel bits [3] according to the UE
category indicated by ue-Category (without suffix) [4]. In determining k, the UE should give priority to
sotring soft channel bits corresponding to lower values of k, wₖ shall correspond to a received soft channel
bit. The range wₖ wₖ₊₁, . . . , w_{mod(k+n}_{_{SB}}_{-1, N}_{_{cb}}), may include subsets not containing received soft channel bits.

Referring to Table 9, a UE divides the entire soft buffer area (TOTAL_SOFT_SIZE) by the number (N) of serving DL cell(s) (hereinafter, ‘Sv_DLCell’) set to the UE and allocates a soft buffer area with the same size (TOTAL_SOFT_SIZE/N) to each Sv_DLCell. The soft buffer area (TOTAL_SOFT_SIZE/N) allocated to each Sv_DLCell is divided again based on at least one of the maximum number of DL HARQ processes (hereinafter, ‘MAX_DLPC’) according to Sv_DLCell, the number of CB (code block) according to Sv_DLCell, and K_{MIMO} value according to Sv_DLCell. The K_{MIMO} value is set to 2 when a transmission mode corresponds to one selected from the group consisting of TM 3, 4, 8, 9, and 10 and the K_{MIMO} value is set to 1 for the rest of transmission modes. A value of the MAX_DLPC of Sv_DLCell is determined by DL reference HARQ timeline information applied to the Sc_DLCell, i.e., DL reference HARQ configuration information.

Unlike a licensed band based cell (hereinafter, ‘LCell’), an unlicensed band based UCell performs communication according to an aperiodic or discontinuous RRP configuration. In other word, it can be comprehended as a data transmission/reception operation in the UCell is opportunistically performed. Hence, it may be able to configure or define the data transmission/reception in the UCell to be performed based on a relatively wider frequency resource or a bandwidth unit in advance in consideration of the aforementioned characteristic. A resource or a bandwidth used for the data transmission/reception of the UCell can be configured to be greater than that of the LCell. By doing so, it may be able to perform data transmission/reception of an amount as much as possible in a temporarily secured UCell RRP.

Since data transmission/reception characteristic of the LCell and data transmission/reception characteristic of the UCell are different from each other, when CA is performed on the LCell and the UCell, if a soft buffer area with the same size is allocated to the LCell and the UCell, it may be inefficient in terms of radio resource utilization of the UCell and the LCell. For example, if a soft buffer area with the same size is semi-statically or statically allocated to the LCell and the UCell, which is used with a relatively low frequency, a data peak transfer rate of the LCell or a data maximum transfer rate of the LCell can be restricted. This is because, since a scheduler relatively less allocates LCell-related soft buffer area which is used with a relatively high frequency, there may exist a restriction on the data peak transfer rate of the LCell or the data maximum transfer rate of the LCell.

Hence, when CA is performed on at least one LCell (e.g., L number of LCells) and at least one UCell (e.g., U number of UCells), the present invention proposes methods of efficiently managing/dividing a soft buffer of a UE.

When an UCell has a TDD frame structure, RRP can be configured by DL SFs only or a combination of DL SF and UL DF. And, a maximum RRP size according to UCell (hereinafter, ‘MAX RRP SIZE’) can be configured to be different among at least a part of UCells or can be configured independently. For example, RRP of a positive integer less than 5 can be semi-statically, statically, or dynamically set/reset to an UCell where the MAX RRP SIZE corresponds to 4. Examples described in the following can be defined to be restrictively applied to a case that an UCell is used by SSFS scheme or MSFS scheme only. And, the examples described in the following can be defined to be restrictively applied to a case that an UCell is used by CCS scheme or SFS scheme only. And, the examples described in the following can extensively applied to a CA situation of (L+U) number of LCells.

For example, if all or a part of schemes proposed in the present invention are applied, it may be able to differently configure a soft buffer size which is allocated according to all or a part of cells. Or, it may be able to differently configure a soft buffer size which is allocated according to a different cell type (e.g., UCell, LCell). In this case, for example, if all or a part of the schemes proposed in the present invention are applied, it may be able to configure a soft buffer size allocated to UCell to be relatively smaller or bigger than a soft buffer size allocated to LCell.

Embodiment indexes indicating embodiments described in the following are intended to help understand the present invention. Although embodiments have a different index, the embodiments can be combined with each other. The scope of right of the present invention is not restricted by an order of the embodiment indexes.

Soft Buffer area Configuration of LCell and UCell

### Embodiment 1

According to one embodiment, a size of the total soft buffer area for L number of LCells (hereinafter, ‘SFSIZE_TOTAL_LCELL’) and a size of the total soft buffer area for U number of UCells (hereinafter, ‘SFSIZE_TOTAL_UCELL’) can be determined based on a predefined or signaled parameter.

The signaled parameter can include a ratio between the SFSIZE_TOTAL_UCELL and the SFSIZE_TOTAL_LCELL. Specifically, if ‘SFSIZE_TOTAL_LCELL:SFSIZE_TOTAL_UCELL=M:N’ is configured, the size of the total soft buffer area for L number of LCells is configured by ‘TOTAL_SOFT_SIZE*M/(M+N)’ and the size of the total soft buffer area for U number of UCells can be configured by ‘TOTAL_SOFT_SIZE*N/(M+N)’.

A ratio value can be independent from the numbers of the LCells and the UCells and/or MAX_DLPC value per cell.

For example, the ‘TOTAL SOFT_SIZE*M/(M+N)’ can be divided again by the number of LCells to allocate a soft buffer area with the same size to each LCell. Or, the ‘TOTAL_SOFT_SIZE*M/(M+N)’ can be proportionally divided again according to MAX_DLPC (or MAX RRP size) of each LCell. Hence, it is able to allocate a soft buffer area size proportional to MAX_DLPC (or MAX RRP size) of each LCell.

For example, the ‘TOTAL_SOFT_SIZE*N/(M+N)’ can be divided again by the number of UCells to allocate a soft buffer area with the same size to each UCell. Or, the ‘TOTAL_SOFT_SIZE*M/(M+N)’ can be proportionally divided again according to MAX_DLPC (or MAX RRP size) of each UCell. Hence, it is able to allocate a soft buffer area size proportional to MAX_DLPC (or MAX RRP size) of each UCell.

### Embodiment 2

According to one embodiment, a size of the total soft buffer area for L number of LCells and a size of the total soft buffer area for U number of UCells can be determined based on a ratio between the number of LCells (L) and the number of UCells (U).

Specifically, the size of the total soft buffer area for L number of LCells can be configured by ‘TOTAL_SOFT_SIZE*L/(L+U)’ and the size of the total soft buffer area for U number of UCells can be configured by ‘TOTAL_SOFT_SIZE*U/(L+U)’.

For example, the ‘TOTAL_SOFT_SIZE*L/(L+U)’ can be divided again by the number of LCells to allocate a soft buffer area with the same size to each LCell. Or, the ‘TOTAL_SOFT_SIZE*L/(L+U)’ can be proportionally divided again according to MAX_DLPC per LCell. Hence, it may be able to allocate a soft buffer area size proportional to MAX_DLPC of each LCell.

For example, the ‘TOTAL SOFT SIZE*U/(L+U)’ can be divided again by the number of UCells to allocate a soft buffer area with the same size to each UCell. Or, the ‘TOTAL_SOFT_SIZE*U/(L+U)’ can be proportionally divided again according to MAX_DLPC per UCell. Hence, it may be able to allocate a soft buffer area size proportional to MAX_DLPC of each UCell.

### Embodiment 3

The embodiment 1 and the embodiment 2 can be combined with each other. A size of the total soft buffer area for L number of LCells and a size of the total soft buffer area for U number of UCells can be determined by aggregating/combining a predefined or signaled ratio (refer to embodiment 1) between SFSIZE_TOTAL_LCELL and SFSIZE_TOTAL_UCELL and a ratio (refer to embodiment 2) between the number (L) of LCells and the number (U) of UCells with each other.

Specifically, if ‘SFSIZE_TOTAL LCELL:SFSIZE_TOTAL_UCELL=M:N’ is configured, the size of the total soft buffer area for L number of LCells is configured by ‘TOTAL_SOFT_SIZE*M*L/(M*L+N*U)’ and the size of the total soft buffer area for U number of UCells can be configured by ‘TOTAL_SOFT_SIZE*N*U/(M*L+N*U)’.

For example, the ‘TOTAL_SOFT_SIZE*M*L/(M*L+N*U)’ can be divided again by the number of LCells to allocate a soft buffer area with the same size to each LCell. Or, the ‘TOTAL_SOFT_SIZE*M*L/(M*L+N*U)’ can be proportionally divided again according to MAX_DLPC per LCell. Hence, it may be able to allocate a soft buffer area size proportional to MAX_DLPC of each LCell.

For example, the ‘TOTAL_SOFT_SIZE*N*U/(M*L+N*U)’ can be divided again by the number of UCells to allocate a soft buffer area with the same size to each UCell. Or, the ‘TOTAL_SOFT_SIZE*N*U/(M*L+N*U)’ can be proportionally divided again according to MAX_DLPC per UCell (or MAX RRP size). Hence, it may be able to allocate a soft buffer area size proportional to MAX_DLPC (or MAX RRP size) of each UCell.

### Embodiment 4

According to one embodiment, it may be able to determine a size of a soft buffer area of a cell in proportion to MAX_DLPC of a cell. It may be able to configure the present embodiment to be exceptionally applied to a CA situation between LCell and UCell. A soft buffer area size proportional to MAX_DLPC of a cell is allocated to the cell.

Specifically, assume that CA is performed on two LCells (LCell#A, LCell#B) and one UCell (UCell#A) and the LCell#A, the LCell#B, and the UCell#A have 10 MAX_DLPC, 7 MAX_DLPC, and 4 MAX_DLPC, respectively. In this case, soft buffer sizes of the LCell#A, the LCell#B, and the UCell#A are allocated by ‘TOTAL_SOFT_SIZE*10/(10+7+4)’, ‘TOTAL_SOFT_SIZE*7/(10+7+4)’, and ‘TOTAL_SOFT_SIZE*4/(10+7+4)’, respectively.

In the present embodiment, a size of the total soft buffer area for L number of LCells is determined by ‘TOTAL_SOFT_SIZE*SUM_MXDP_L/(SUM_MXDP_L+SUM_MXDP_U)’ and a size of the total soft buffer area for U number of UCells is determined by ‘TOTAL_SOFT_SIZE*SUM_MXDP_U/(SUM_MXDP_L+SUM_MXDP_U)’ according to a ratio value between the sum of MAX_DLPC values of the L number of LCells (hereinafter, ‘SUM_MXDP_L’) and the sum of MAX_DLPC values of the U number of UCells (hereinafter, ‘SUM_MXDP_U’).

For example, the ‘TOTAL_SOFT_SIZE*SUM_MXDP_L/(SUM_MXDP_L+SUM_MXDP_U)’ is divided again by the number of LCells to allocate a soft buffer area with the same size to each LCell. Or, the ‘TOTAL_SOFT_SIZE*SUM_MXDP_L/(SUM_MXDP_L+SUM_MXDP_U)’ can be proportionally divided again according to MAX_DLPC (or MAX RRP size) of each LCell. Hence, it may be able to allocate a soft buffer area size proportional to MAX_DLPC (or MAX RRP size) of each LCell.

For example, the ‘TOTAL_SOFT_SIZE*SUM_MXDP_U/(SUM_MXDP_L+SUM_MXDP_U)’ is divided again by the number of UCells to allocate a soft buffer area with the same size to each UCell. Or, the ‘TOTAL_SOFT_SIZE*SUM_MXDP_U/(SUM_MXDP_L+SUM_MXDP_U)’ can be proportionally divided again according to MAX_DLPC of each UCell. Hence, it may be able to allocate a soft buffer area size proportional to MAX_DLPC of each UCell.

According to a different embodiment, a soft buffer area size of each cell can be proportionally determined according to MAX RRP size of each cell. The present embodiment can be configured to be exceptionally applied to a CA situation between LCell and UCell. A MAX RRP size of LCell can be configured by a predefined/signaled value (e.g., 10).

Specifically, assume that CA is performed on one LCell (LCell#A) and two UCells (UCell#A and UCell#B) and the LCell#A, the UCell#A, and the UCell#B have 10 MAX RRP size, 4 MAX RRP size, and 5 MAX RRP size, respectively. In this case, soft buffer sizes of the LCell#A, the UCell#A, and the UCell#B are allocated by ‘TOTAL_SOFT_SIZE*10/(10+4+5)’, ‘TOTAL_SOFT_SIZE*4/(10+4+5)’, and ‘TOTAL_SOFT_SIZE*5/(10+4+5)’, respectively.

In the present embodiment, a size of the total soft buffer area for L number of LCells is determined by ‘TOTAL_SOFT_SIZE*SUM_MXRRP_L/(SUM_MXRRP_L+SUM_MXRRP_U)’ and a size of the total soft buffer area for U number of UCells is determined by ‘TOTAL_SOFT_SIZE*SUM_MXRRP_U/(SUM_MXRRP_L+SUM_MXRRP_U)’ according to a ratio between the sum of MAX_RRP sizes of the L number of LCells (hereinafter, ‘SUM_MXRRP_L’) and the sum of MAX_RRP sizes of the U number of UCells (hereinafter, ‘SUM_MXRRP_U’).

### Embodiment 5

According to the aforementioned embodiments 1, 2, 3, and 4, if a size of the total soft buffer area for L number of LCells (SFSIZE_TOTAL_LCELL) is divided again by the number of LCells, a soft buffer area with the same size can be allocated to each LCell.

On the contrary, if a size of the total soft buffer area for U number of UCells (SFSIZE_TOTAL_UCELL) is divided again in proportion to MAX_DLPC or MAX RP size of a UCell, it may be able to allocate a soft buffer area size proportional to MAX_DLPC or MAX RRP size of the UCell.

Specifically, assume that CA is performed on two LCells (LCell#A and LCell#B) and two UCells (UCell#A and UCell#B) and the LCell#A, the LCell#B, the UCell#A, and the UCell#B have 10 MAX_DLPC, 7 MAX_DLPC, 4 MAX_DLPC, and 2 MAX_DLPC, respectively. In this case, soft buffer sizes of the LCell#A and the LCell#B are allocated by ‘SFSIZE_TOTAL_LCELL/2’ and ‘SFSIZE_TOTAL_LCELL/2’, respectively. Soft buffer sizes of the UCell#A and the UCell#B are allocated by ‘SFSIZE_TOTAL_UCELL*4/(4+2)’ and ‘SFSIZE_TOTAL_UCELL*2/(4+2)’, respectively.

### Embodiment 6

According to one embodiment, in order to efficiently use a soft buffer in an aperiodic/discontinuous RRP of UCell, a plurality of predefined/signaled UCells may share at least a part of soft buffer areas.

As an example, assume that CA is performed on one LCell (LCell#A) and 4 UCells (UCell#A, UCell#B, UCell#C, and UCell#D), the UCell#A and the UCell#B are configured to share a soft buffer area, and the UCell#C and the UCell#D are configured to share a soft buffer area via a predefined signal. A representative MAX_DLPC (hereinafter, ‘REFER_MXDLPC_AB’) of the UCell#A and the UCell#B configured to share the soft buffer area can be configured by ‘MIN{(MAX_DLPC of UCell#A+MAX_DLPC of UCell#B), 8}’; ‘MIN{MAX(MAX_DLPC of UCell#A, MAX_DLPC of UCell#B), 8}’; ‘MIN{MIN(MAX_DLPC of UCell#A, MAX_DLPC of UCell#B), 8}, or a predefined/signaled value (e.g., 8). In this case, MIN( )corresponds to a minimum value among input variables and MAX( )corresponds to a maximum value among input variables.

Similarly, it may also be able to deduct a representative MAX_DLPC (hereinafter, ‘REFER_MXDLPC_CD’) of the UCell#C and the UCell#D that share a soft buffer area.

Meanwhile, it may be able to configure a UE to share a soft buffer area between cells only when all of the total soft buffer area of the UE or the remaining soft buffer area except a certain soft buffer area are fully used. If the total soft buffer area of the UE or the remaining soft buffer area except the certain soft buffer area is not fully used, a soft buffer area not in use can be used without being shared.

As an example, ‘UCell#A and UCell#B’, and ‘UCell#C and UCell#D’ may use a shared soft buffer area in a manner of dividing the shared soft buffer area again by a representative MAX_DLPC. Although the shared soft buffer area is divided again by the representative MAX_DLPC, a practical MAX_DLPC value, which is managed for individual cells, can be configured to be bigger or smaller than the representative MAX_DLPC. Moreover, the individual cells may manage a HARQ operation/HARQ process (index) according to MAX_DLPC of the individual cells.

As an example, UCells sharing a soft buffer area can be considered as a virtual cell or predetermined number of virtual cells. If CA is performed on one LCell and four UCells, UCell#A and UCell#B share a soft buffer area, and UCell#C and UCell#D share a soft buffer area, it can be considered as CA performed on one LCell and two UCells in terms of a virtual cell. In other word, the aforementioned embodiments 1, 2, 3, 4 and 5 can be implemented under the assumption that CA is performed on LCell#A, UCell of REFER_MXDLPC_AB, and UCell of REFER_MXDLPC_BC.

If LCell and UCell share at least a part of a soft buffer area, the embodiment 6 can also be applied to a case that a plurality of LCells share at least a part of a soft buffer area.

Meanwhile, if it is necessary to store additional bits in a state that a shared soft buffer area is filled with received soft channel bits, it may be able to determine whether to store the additional bits according to a predefined priority rule. The rules (i), (ii), (iii), and (iv) described in the following can be configured to be applied only when UCells share a soft buffer area. And, the rules (i), (ii), (iii), and (iv) described in the following can be configured to be applied only when the total soft buffer area or a certain soft buffer area of a UE is fully used.

As an example, assume that a soft buffer area is configured to be shared by LCell#0, UCell#0, and UCell#1 and the (specific) soft buffer area is filled with received soft channel bits according to a DL HARQ process#0 of the LCell#0 and a DL HARQ process#1 of the UCell#1.

(i) If it is necessary for a UE to additionally store received soft channel bits in the shared (specific) soft buffer area according to a DL HARQ process#1 of the LCell#0, it may be able to define a rule that the received soft channel bits according to the DL HARQ process#1 of the UCell#1 are dropped and the received soft channel bits according to the DL HARQ process#1 of the LCell#0 are stored in the soft buffer area. This can be interpreted as LCell has higher priority compared to UCell in case of using the shared soft buffer area.

(ii) If it is necessary for a UE to additionally store received soft channel bits according to a DL HARQ process#1 of the UCell#0, it may be able to define a rule that the received soft channel bits according to the DL HARQ process#1 of the UCell#1 are dropped and the received soft channel bits according to the DL HARQ process#1 of the UCell#0 are stored in the soft buffer area. This can be interpreted as a cell of a relatively low SERVCELLINDEX has higher priority among cells of the same type.

(iii) If it is necessary for a UE to additionally store received soft channel bits according to a DL HARQ process#0 of the UCell#1, it may be able to define a rule that the received soft channel bits according to the DL HARQ process#1 of the UCell#1 are dropped and the received soft channel bits according to the DL HARQ process#0 of the UCell#1 are stored in the soft buffer area. This can be interpreted as a cell of a relatively low DL HARQ process index has higher priority among cells of the same type.

(iv) As a further different example, it may be able to define priority based on at least one of rules including a rule that LCell has priority lower than priority of UCell among cells of a different type, a rule that a cell including a relatively higher SERVCELLINDEX has higher priority among cells of the same type, a rule that a cell including a relatively higher DL HARQ process index has higher priority among cells of the same type, a rule that a cell firstly or most recently stored/updated/aggregated a received soft channel bit or a received soft channel bit according to a DL HARQ process of the cell has higher priority (irrespective of a cell type (or in case of the same cell type)), when a timer is set to individual cells or every DL HARQ process of the cells, a rule that a cell of which a value of the timer is biggest or smallest has higher priority or a DL HARQ process of the cell has higher priority (irrespective of a cell type (or in case of the same cell type)), a rule that priority is determined based on an order of SERVCELLINDEX (irrespective of a cell type (or in case of the same cell type)), and a rule that priority is determined based on an order of DL HARQ process index (irrespective of a cell type (or in case of the same cell type)).

### Embodiment 7

If UCell is targeting traffic offloading rather than the increase of peak throughput of a system, in order to prevent the peak throughput from being reduced by LCell, it may define a rule that N′_{soft} mentioned earlier in Table 9 is divided by the number (L) of LCells (e.g., N′_{soft}/L). As shown in Table 9, the N′_{soft} corresponds to ‘total number of soft channel bits’, in particular, a size of the total soft buffer, of a UE according to a category of the UE. In this case, a scheduler or a base station can prevent a soft buffer area collision between UCell and LCell in a soft buffer of the UE. This can be interpreted as a soft buffer area is shared between the UCell and the LCell or the UCell priority lower than that of the LCell in occupying the soft buffer area.

### Embodiment 8

According to one embodiment, N′_{soft} can be divided by the sum of the number (L) of LCells and the number (U) of UCells (e.g., N′_{soft}/(L+U)). This can be interpreted as the LCell and the UCell are evenly handled in case of dividing a soft buffer area.

### Embodiment 9

As an example, a UE may divide a soft buffer area like ‘N′_{soft}/{L+f(U)}’. In this case, ‘f(U)’ may correspond to a function outputting a value smaller than U according to ‘(A·U)’ or other condition. A value of the A can be configured via predefined signaling or can be explicitly or implicitly configured according to a ratio (e.g., ‘U/(L+U)’ or ‘L/(L+U)’) between the number (L) of LCells and the number (U) of UCells.

### Embodiment 10

As an example, if ‘(L+U)≦Kc’ is satisfied, a UE can divide a soft buffer area like ‘N′_{soft}/(L+U)’. On the contrary, if ‘(L+U)>Kc’ and ‘L<Kc’ are satisfied, the UE can divide a soft buffer area like ‘N′_{soft}/Kc’. If ‘(L+U)>Kc’ and ‘L>Kc’ are satisfied, the UE can divide a soft buffer area like ‘N′_{soft}/L’. It may refer to Table 10 in the following for the definition of the Kc.

### Embodiment 11

In case of performing a DL communication operation in UCell, it may consider MINIMUM RRT (reserved resource time) of Nms. If the maximum number of DL SFs capable of being continuously scheduled during Nms corresponds to M, occupation of UCell can be configured to be lowered to ‘M/N’ when N_{IR} (refer to Table 10) and n_{sB} (refer to Table 9) are calculated.

For example, although N is configured by 8 ms, since maximum occupation time regulation of an unlicensed band is regulated by 4 ms, assume that M is configured by 7. For example, assume that PDSCH transmission during the maximum occupation time regulation=4 ms, CCA (clear channel assessment) operation during 1 ms, and PDSCH transmission during maximum occupation time regulation=4 ms are performed in a section of N=8 ms. When N_{IR} and n_{sB} are calculated, a UE lowers occupation of UCell to ‘7/8’.

And, it may be able to determine a final N_{IR} and n_{SB} for UCell by multiplying N_{IR} and n_{SB} calculated by equations shown in Tables 9 and 10 by ‘M/N’, respectively. Subsequently, an additionally generated soft buffer area can be uniformly redistributed to L number of LCells.

MAX DLPC Configuration of UCell

In the following, a method of configuring MAX_DLPC of UCell is proposed. A MAX RRP size of an UCell can be differently or individually configured among at least a part of UCells. For example, RRP of a positive integer less than 5 can be semi-statically/statically/dynamically (re)set to an UCell configured by MAX RRP size=4. Moreover, methods proposed in the following can be configured to be restrictively applied to a case that UCell RRP is configured by DL SFs only.

### Embodiment 12

MAX_DLPC of an UCell can be configured by a value identical to a MAX RRP size of the UCell. For example, although LCell is configured by MAX_DLPC=8, UCell can be configured by MAX_DLPC=MAX RRP size=4. This can be interpreted as the MAX_DLPC of the UCell is configured by assuming maximum DL data scheduling in the RRP of the MAX RRP size.

As a different example, MAX_DLPC of an UCell can be configured by a value identical to the maximum number of DL SFs constructing RRP of the UCell.

### Embodiment 13

MAX_DLPC of UCell can be configured by a predefined or signaled value (e.g., 8). As an example, the MAX_DLPC of the UCell can be configured irrespective of a MAX RRP size of the UCell and the maximum number of DL SFs constructing RRP.

According to one embodiment, if MAX_DLPC relatively smaller than the MAX RRP size of the UCell or a practical MAX_DLPC, which is capable of being configured in consideration of the maximum number of DL SFs constructing RRP, is signaled/configured, it may be able to increase minimum TB size or minimum CB size capable of being received/buffered by a UE.

### Embodiment 14

If it is able to perform fastest retransmission for DL data (e.g., PDSCH), which is received in a first DL SF belonging to UCell RRP, after Kms (e.g., according to a predefined UCell DL HARQ timeline), MAX_DLPC of the UCell can be configured by the maximum number of DL SFs (hereinafter, ‘MAX_DLSF_KMS’) capable of being included in Kms section including the first DL SF.

For example, the MAX_DLSF_KMS can be deducted under an assumption that the predefined/signaled number of UCell RRPs are continuously configured.

And, the MAX_DLSF_KMS can also be calculated by excluding a resource for CS which is performed between continuously configured RRPs, a resource for TX/RX switching, and an SF including the resources.

### Embodiment 15

Referring to Table 9, a soft buffer area allocated to a cell can be divided again by a result value of a function ((i.e., MIN (M_LIMIT, MAX_DLPC)) having MAX_DLPC of the cell as an input variable.

As an example, in case of UCell, M_LIMIT value of the function can be assumed in a manner of being different from LCell (i.e., M_LIMIT=8). For example, in case of UCell, the M_LIMIT value of the function can be assumed by ‘M_LIMIT=4’. The M_LIMIT of the Ucell can be forwarded via a predefined signal or can be fixed by a specific value.

And, as an example, in the present embodiment or other embodiments of the present invention, Mₗᵢₘᵢₜ(M_LIMIT) value can be independently configured in every cell (e.g., ‘LCELL→8’, ‘UCELL→4’) or can be differently configured in all or at least a part of cells. For example, the Mₗᵢₘᵢₜ can be signaled by a base station.

The aforementioned embodiments can be configured to be restrictively applied to a case that a UE fails to receive a CB (code block) of a specific TB (e.g., TB of PDSCH) at a random SF timing and the UE stores at least a part of received soft channel bits for the CB in a soft buffer of the UE only.

Soft Buffer Area Configuration in Massive CA

According to 3GPP LTE-A standard until Rel.12, CA is supported for up to maximum 5 cells. Yet, according to the embodiments of the present invention, it is able to support CA of cells more than 5 to support increasing DL/UL data traffic. For example, it may be able to support CA of 32 cells. In the following, methods for an eNB or a UE to efficiently manage a limited soft buffer area in massive CA are proposed. For example, the methods proposed in the following can be extensively applied to efficiently manage a soft buffer in CA situation in which at least one or more UCells are included.

For clarity, assume that all cells are classified into at least two or more cell groups (hereinafter, ‘CG’) (e.g., CG#0, CG#1).

The above CG configuration can mitigate a phenomenon that PUCCH or PUSCH piggyback based UCI transmission or DCI transmission is concentrated on a partial cell (e.g., PCell). Specifically, a cell in which PUCCH transmission is performed can be independently configured according to a CG. Or, a cell in which CSS (common search space) is configured can be independently configured according to a CG

A CG can be configured by a combination of UCell(s) and LCell(s), LCell(s) only, or UCell(s) only. The UCell(s) can be configured to be restrictively configured by SCell(s) only or can be configured to be CCS (cross carrier scheduled) by the LCell(s).

Table 10 shows a method of performing rate matching (hereinafter, ‘RM’) by assuming a calculated soft buffer size when a cell transmits TB or CB in DL in 3GPP LTE-A system. It may refer to Table 10 and Table 11 together. More specifically, Table 10-1 shows rate matching of turbo coded transport channels, Table 10-2 shows a sub-block interleaver in rate matching, and Table 10-3 shows bit collection, selection, and transmission in rate matching.

[Table 10-2]

[Table 10-3]

Table 11 shows a category of a UE and parameters determined according to the category. More specifically, Table 11-1 shows DL physical parameter values configured according to the category of the UE, Table 11-2 shows UL physical parameter values configured according to the category of the UE, Table 11-3 shows a buffer size of layer 2 configured according to the category of the UE, Table 11-4 shows maximum size of MCH TB per TTI configured according to the category of the UE, and Table 11-5 shows a type of half-duplex FDD operation configured according o the category of the UE.

TABLE 11
ue-Category (Section 4.1 in Std.)
The field ue-Category defines a combined uplink and downlink capability. The parameters set by
the UE Category are defined in subclause 4.2. Tables 4.1-1 and 4.1-2 define the downlink and,
respectively, uplink physical layer parameter values for each UE Category. A UE indicating
category 6 or 7 shall also indicate category 4. A UE indicating category 8 shall also indicate
category 5. A UE indicating category 9 shall also indicate category 6 and 4. A UE indicating
category 10 shall also indicate category 7 and 4. Table 4.1-4 defines the minimum capability for
the maximum number of bits of a MCH transport block received within a TTI for an MBMS
capable UE.
Downlink physical layer parameter values set by the field ue-Category(Table 4.1-1 in Std.)

| | Maximum number | Maximum | Total | Maximum |
|---|---|---|---|---|
| | of DL-SCH | number of bits of | number | number of |
| | transport block | a DL-SCH | of | supported layers |
| | bits received | transport block | soft | for spatial |
| UE | within a | received within a | channel | multiplexing in |
| Category | TTI (Note 1) | TTI | bits | DL |
| Category 0 | 1000 | 1000 | 25344 | 1 |
| (Note 2) | | | | |
| Category 1 | 10296 | 10296 | 250368 | 1 |
| Category 2 | 51024 | 51024 | 1237248 | 2 |
| Category 3 | 102048 | 75376 | 1237248 | 2 |
| Category 4 | 150752 | 75376 | 1827072 | 2 |
| Category 5 | 299552 | 149776 | 3667200 | 4 |
| Category 6 | 301504 | 149776 (4 layers) | 3654144 | 2 or 4 |
| | | 75376 (2 layers) | | |
| Category 7 | 301504 | 149776 (4 layers) | 3654144 | 2 or 4 |
| | | 75376 (2 layers) | | |
| Category 8 | 2998560 | 299856 | 35982720 | 8 |
| Category 9 | 452256 | 149776 (4 layers) | 5481216 | 2 or 4 |
| | | 75376 (2 layers) | | |
| Category 10 | 452256 | 149776 (4 layers) | 5481216 | 2 or 4 |
| | | 75376 (2 layers) | | |

Uplink physical layer parameter values set by the field ue-Category (Table 4.1-2 in Std.)

| | Maximum number | Maximum | |
|---|---|---|---|
| | of UL-SCI-4 | number of bits | |
| | transport block bits | of an UL-SCH | |
| | transmitted | transport block | Support for |
| UE | within | transmitted | 64 QAM |
| Category | a TTI | within a TTI | in UL |
| Category 0 | 1000 | 1000 | No |
| Category 1 | 5160 | 5160 | No |
| Category 2 | 25455 | 25456 | No |
| Category 3 | 51024 | 51024 | No |
| Category 4 | 51024 | 51024 | No |
| Category 5 | 75376 | 75376 | Yes |
| Category 6 | 51024 | 51024 | No |
| Category 7 | 102048 | 51024 | No |
| Category 8 | 1497760 | 149776 | Yes |
| Category 9 | 51024 | 51024 | No |
| Category 10 | 102048 | 51024 | No |

Total layer 2 bufferizes set by the field ue-Category (Table 4.1-3 in Std.)

| UE | Total layer 2 buffer |
|---|---|
| Category | size [bytes] |
| Category 0 | 20 000 |
| Category 1 | 150 000 |
| Category 2 | 700 000 |
| Category 3 | 1 400 000 |
| Category 4 | 1 900 000 |
| Category 5 | 3 500 000 |
| Category 6 | 3 300 000 |
| Category 7 | 3 800 000 |
| Category 8 | 42 200 000 |
| Category 9 | 4 800 000 |
| Category 10 | 5 200 000 |

Maximum number of bits of a MCH transport block received within a TTI set by the field ue-
Category for an MBMS capable UE (Table 4.1-4 in Std.)

| | Maximum |
|---|---|
| | number of bits |
| | of a MCH |
| | transport block |
| UE | received within |
| Category | a TTI |
| Category 0 | 4584 |
| Category 1 | 10296 |
| Category 2 | 51024 |
| Category 3 | 75376 |
| Category 4 | 75376 |
| Category 5 | 75376 |
| Category 6 | 75376 |
| Category 7 | 75376 |
| Category 8 | 75376 |
| Category 9 | 75376 |
| Category 10 | 75376 |

Half-duplex FDD operation type set by the field ue-Category for a half-duplex FDD capable
UE(Table 4.1-5 in Std.)

| UE | Half-duplex FDD |
|---|---|
| Category | operation type |
| Category 0 | Type B |
| Category 1 | Type A |
| Category 2 | Type A |
| Category 3 | Type A |
| Category 4 | Type A |
| Category 5 | Type A |
| Category 6 | Type A |
| Category 7 | Type A |
| Category 8 | Type A |
| Category 9 | Type A |
| Category 10 | Type A |

NOTE 1:
In carrier aggregation operation, the DL-SCH processing capability can be shared by the UE with that of MCH received from a serving cell. If the total eNB scheduling for DL-SCH and an MCH in one serving cell at a given TTI is larger than the defined processing capability, the prioritization between DL-SCH and MCH is left up to UE implementation.
NOTE 2:
Within one TTI, a UE indicating category 0 shall be able to receive up to 1000 bits for a transport block associated with C-RNTI/P-RNTI/SI-RNTI/RA-RNTI and up to 2216 bits for another transport block associated with P-RNTI/SI-RNTI/RA-RNTI

Referring to Tables 10 and 11, Kc value corresponds to maximum number of cell(s) capable of being supported when maximum code rate (hereinafter, ‘MCR’) is applied to all cell(s)-related TB/CB. Alternately, when ‘maximum number of supported layers for spatial multiplexing in DL’ based on the UE category corresponds to 2 or more, the Kc value may correspond to the maximum number of cell(s) capable of being supported after assuming that all cell(s)-related TM is configured by one of TM 3, 4, 8, 9, and 10. Alternately, the Kc value may correspond to the maximum number of cell(s) capable of being supported after assuming that all cell(s)-related MDL_HARQ is configured by 8.

Specifically, the Kc value (5) for a UE of category 8 can be deducted by putting 35982720, 2/3, 2, 8, and 8 in N_{soft}, MCR, K_{MIMO}, M_{DL}_{_}_{HARQ}, and Mₗᵢₘᵢₜ parameters of equation 1, respectively.

$$( 299856 = ⌊ \frac{{N}_{soft}}{{K}_{C} \cdot {K}_{MIMO} \cdot min ( {M}_{DL \_ HARQ} , {M}_{limit} )} ⌋ \cdot MCR ) \qquad [ Equation 1 ]$$

In equation 1, a value of 35982720 and a value of 299856 correspond to category 8-related ‘total number of soft buffer channel bits (i.e., ‘N_{soft}’) and ‘maximum number of bits of a DL-SCH TB received within a TTI’, respectively. For example, the value of 299856 can be obtained by putting 35982720, 2/3, 5, 2, 8, and 8 in N_{soft}, MCR, K_{C}, K_{MIMO}, M_{DL}_{_}_{HARQ}, and Mₗᵢₘᵢₜ parameters of equation 2.

$$( ⌊ \frac{{N}_{soft}}{{K}_{C} \cdot {K}_{MIMO} \cdot min ( {M}_{DL \_ HARQ} , {M}_{limit} )} ⌋ \cdot MCR ) \qquad [ Equation 2 ]$$

In the following, a method of efficiently managing/dividing a soft buffer of a UE in CA situation of a plurality of cell groups (e.g., CG#0, CG#1) is explained according to embodiments of the present invention.

### Embodiment 16

According to one embodiment, a size of the total soft buffer area for a CG#0 (hereinafter, ‘SFSIZE_TOTAL_CG0’) and a size of the total soft buffer area for a CG#1 (hereinafter, ‘SFSIZE_TOTAL_CG1’) can be determined based on a predefined or signaled parameter.

The signaled parameter can include a ratio between the SFSIZE_TOTAL_CG0 and the SFSIZE_TOTAL_CG1. Specifically, if ‘SFSIZE_TOTAL_CG0:SFSIZE_TOTAL_CG1=M:N’ is configured, the size of the total soft buffer for the CG#0 is configured by ‘TOTAL_SOFT_SIZE*M/(M+N)’ and the size of the total soft buffer for the CG#1 is configured by ‘TOTAL_SOFT_SIZE*N/(M+N)’.

As a different example, a size of the total soft buffer area can be equally allocated between CGs without signaling a ratio value. Specifically, when the entire CA is configured by two CGs (CG#0, CG#1), a size of the total soft buffer area for the CG#0 is configured by ‘TOTAL_SOFT_SIZE*½’ and a size of the total soft buffer area for the CG#1 can be configured by ‘TOTAL_SOFT_SIZE*½’.

### Embodiment 17

A size of the total soft buffer area according to a CG can be determined in proportion to the number of cells constructing the CG. For clarity, the number of cells belonging to a CG#0 is referred to as ‘TONUM_CELL_CG0’ and the number of cells belonging to a CG#1 is referred to as ‘TONUM_CELL_CG1’.

Specifically, if the TONUM_CELL_CG0 corresponds to A and the TONUM_CELL_CG1 corresponds to B, it may be able to represent as ‘SFSIZE_TOTAL_CG0=TOTAL_SOFT_SIZE*A/(A+B)’ and ‘SFSIZE_TOTAL_CG1=TOTAL_SOFT_SIZE*B/(A+B)’.

### Embodiment 18

According to one embodiment, the embodiment 16 and the embodiment 17 can be combined with each other. A size of the total soft buffer area for a CG#0 and a size of the total soft buffer area for a CG#1 can be determined by aggregating/combining a predefined/signaled ratio (refer to embodiment 16) between SFSIZE_TOTAL_CG0 and SFSIZE_TOTAL_CG1 with a ratio (refer to embodiment 17) between TONUM_CELL_CG0(A) and TONUM_CELL_CG1(B).

Specifically, if ‘SFSIZE_TOTAL_CG0:SFSIZE_TOTAL_CG1=M:N’ is configured, the size of the total soft buffer for the CG#0 is configured by ‘TOTAL_SOFT_SIZE*M*A/(M*A+N*B)’ and the size of the total soft buffer for the CG#1 is configured by ‘TOTAL_SOFT_SIZE*N*B/(M*A+N*B)’.

### Embodiment 19

According to one embodiment, a size of the total soft buffer area of a CG can be determined in proportion to the total MAX_DLPC of cells constructing the CG

Specifically, assume that a CG#0 includes two cells (cell#A and cell#B), a CG#1 includes one cell (cel#C), and the cell#A, the cell#B, and the cell#C have 10, 7, and 4 MAX_DLPCs, respectively. A size of the total sift buffer area for the CG#0 is configured by ‘TOTAL_SOFT_SIZE*(10+7)/(10+7+4)’ and a size of the total sift buffer area for the CG#1 is configured by ‘TOTAL_SOFT_SIZE*4/(10+7+4)’.

As a different example, a size of a soft buffer area according to a cell is preferentially determined in proportion to MAX_DLPC according to a cell. Then, a size of the total soft buffer area for the CG#0 and a size of the total soft buffer area for the CG#1 can be determined based on the size of the soft buffer area proportional to the MAX_DLPC. The size of the total buffer area for the CG#0 is configured by the sum of sizes of soft buffer areas of cells belonging to the CG#0 and the size of the total buffer area for the CG#1 can be configured by the sum of sizes of soft buffer areas of cells belonging to the CG#1.

Specifically, assume that the CG#0 includes two cells (cell#A and cell#B), the CG#1 includes one cell (cell#C), and the cell#A, the cell#B, and the cell#C have 10, 7, 4 MAX_DLPCs, respectively. In this case, sizes of the cell#A, the cell#B, and the cell#C correspond to ‘TOTAL_SOFT_SIZE*10/(10+7+4)’, ‘TOTAL_SOFT_SIZE*7/(10+7+4)’, and ‘TOTAL_SOFT_SIZE*4/(10+7+4)’, respectively. As a result, the size of the total soft buffer area of the CG#0 becomes ‘TOTAL_SOFT_SIZE*(10+7)/(10+7+4)’ and the size of the total soft buffer area of the CG#1 becomes ‘TOTAL_SOFT_SIZE*4/(10+7+4)’.

### Embodiment 20

A size of the total buffer area according to a CG can be proportionally determined in proportion to the total MAX RRP size of cells constructing the CG In this case, as an example, a MAX RRP size of an LCell can be assumed by a predefined/signaled value (e.g., 10).

Specifically, assume that a CG#0 includes two cells (LCell#A and UCell#B), a CG#1 includes two cells (LCell#C and UCell#D), MAX RRP sizes of the LCell#A and the LCell#C are defined/signaled by 10, and the UCell#B and the UCell#D have 4 and 5 MAX RRP sizes, respectively. In this case, a size of the total soft buffer size for the CG#0 is configured by ‘TOTAL_SOFT_SIZE*(10+4)/(10+4+10+5)’ and a size of the total soft buffer size for the CG#1 can be configured by ‘TOTAL_SOFT_SIZE*(10+5)/(10+4+10+5)’.

As a different example, a size of the total buffer area for a CG can be configured by the sum of sizes of soft buffer areas of cells constructing the CG, after a size of a soft buffer area according to a cell is determined in proportion to an MAX RRP size according to a cell.

Specifically, assume that a CG#0 includes two cells (LCell#A and UCell#B), a CG#1 includes two cells (LCell#C and UCell#D), MAX RRP sizes of the LCell#A and the LCell#C are defined/signaled by 10, and the UCell#B and the UCell#D have 4 and 5 MAX RRP sizes, respectively. In this case, sizes of the LCell#A and the LCell#C are configured by ‘TOTAL_SOFT_SIZE*10/(10+4+10+5)’ and sizes of the soft buffer areas of the UCell#B and the UCell#D are configured by ‘TOTAL_SOFT_SIZE*4/(10+4+10+5)’ and ‘TOTAL_SOFT_SIZE*5/(10+4+10+5)’, respectively. In this case, a size of the total soft buffer size for the CG#0 is configured by ‘TOTAL_SOFT_SIZE*(10+4)/(10+4+10+5)’ and a size of the total soft buffer size for the CG#1 can be configured by ‘TOTAL_SOFT_SIZE*(10+5)/(10+4+10+5)’.

### Embodiment 21

A size of the total soft buffer area of a CG can be configured in proportion to a representative MAX_DLPC according to a CG. The representative MAX_DLPC according to a CG can be deducted according to a predefined rule.

As an example, when a CG#X includes two cells (cell#A and cell#B), a representative MAX_DLPC of the CG#X can be determined by ‘MIN{(MAX_DLPC of cell#A+MAX_DLPC of cell#B), 8}’, ‘MIN{MAX(MAX_DLPC of cell#A, MAX_DLPC of UCell#B), 8}’, ‘MIN{MIN(MAX_DLPC of cell#A, MAX_DLPC of Ucell#B), 8}, or a predefined/signaled value (e.g., 8).

Specifically, assume that a CG#0 includes two cells (Cell#A and Cell#B), a CG#1 includes one cell (Cell#C), and the Cell#A, the Cell#B, and the Cell#C have 10, 7, and 4 MAX_DLPCs, respectively. In this case, a representative MAX_DLPC of the CG#0 becomes 8=MIN{MAX(10, 7), 8)} and a representative MAX_DLPC of the CG#1 becomes 4=MIN{MAX(4), 8)}. In this case, a size of the total soft buffer size for the CG#0 is configured by ‘TOTAL_SOFT_SIZE*8/(8+4)’ and a size of the total soft buffer size for the CG#1 can be configured by ‘TOTAL_SOFT_SIZE*4/(8+4)’.

As a different example, a size of the total soft buffer area of a CG can be determined in proportion to a representative MAX RRP size according to a CG.

For example, assume that an MAX RRP size of an LCell is configured by a predefined/signaled value (e.g., 10). If a CG#X includes two cells (Cell#A and Cell#B), a representative MAX RRP size of the CG#X can be determined by ‘MAX(MAX RRP SIZE of Cell#A, MAX RRP SIZE of Cell#B)’, ‘MIN(MAX RRP SIZE of Cell#A, MAX RRP SIZE of Cell#B)’, ‘(MAX RRP SIZE of Cell#A+MAX RRP SIZE of Cell#B)’, weight value W1 (Cell#A) according to cell, if W2 (Cell#B) is set, ‘MAX{(MAX RRP SIZE of Cell#A)*W1, (MAX RRP SIZE of Cell#B)*W2)’, ‘MIN{(MAX RRP SIZE of Cell#A)*W1, (MAX RRP SIZE of Cell#B)*W2)}’, ‘MIN{(MAX RRP SIZE of Cell#A)*W1+(MAX RRP SIZE of Cell#B)*W2)}’, or a predefined/signaled value.

Specifically, assume that a CG#0 includes two cells (LCell#A and UCell#B), a CG#1 includes two cells (UCell#C and UCell#D), MAX RRP size of the LCell#A is configured by 10, and the UCell#B, the UCell#C, and the UCell#D have 4, 5, and 4 MAX RRP sizes, respectively. In this case, a representative MAX RRP size of the CG#0 becomes 10=MAX(10, 4)) and a representative MAX RRP size of the CG#1 becomes 5=MAX(5, 4). In this case, a size of the total soft buffer size for the CG#0 is configured by ‘TOTAL_SOFT_SIZE*10/(10+5)’ and a size of the total soft buffer size for the CG#1 can be configured by ‘TOTAL_SOFT_SIZE*5/(10+5)’.

It may be able to define a rule that the present embodiment is restrictively applied to CGs configured by UCells only.

### Embodiment 22

In the aforementioned embodiments (e.g., embodiments 16 to 22), if a size of the total soft buffer area of a CG#W is determined, it may be able to determine a size of a soft buffer area of an individual cell belonging to the CG#W.

For clarity, assume that the CG#W includes L number of LCells and U number of UCells. Examples described in the following can be applied instead of the aforementioned embodiments 1 to 6. And, the examples described in the following can be differently applied according to a type of cells belonging to the CG#W.

### Embodiment 22-1

A size of the total buffer area for L number of LCells (hereinafter, ‘SFSIZE_TOTAL_LCELL’) and a size of the total buffer area for U number of UCells (hereinafter, ‘SFSIZE_TOTAL_UCELL’) can be (re)determined according to a predefined/signaled ratio.

Specifically, if ‘SFSIZE_TOTAL_LCELL:SFSIZE_TOTAL_UCELL=M:N’ is signaled, the size of the total buffer area for L number of LCells is configured by ‘TOTAL_SOFT_SIZE*M/(M+N)’ and the size of the total buffer area for U number of UCells is configured by ‘TOTAL_SOFT_SIZE*N/(M+N)’. Subsequently, the ‘TOTAL_SOFT_SIZE*M/(M+N)’ is divided again by the number of LCells and a soft buffer area with the same size can be allocated to each LCell. Or, the ‘TOTAL_SOFT_SIZE*M/(M+N)’ can be divided again in proportion to MAX_DLPC (or MAX RRP size) of LCell. And, the ‘TOTAL_SOFT_SIZE*N/(M+N)’ is divided again by the number of UCells and a soft buffer area with the same size can be allocated to each UCell. Or, the ‘TOTAL_SOFT_SIZE*N/(M+N)’ can be divided again in proportion to MAX_DLPC of UCell.

As a different example, a size of a soft buffer area of each cell can be (re)determined according to a predefined/signaled soft buffer area size (re)allocation ratio of a cell.

Specifically, assume that a CG#W includes one LCell (LCell#A) and two UCells (UCell#A and UCell#B) and ‘LCell#A:UCell#A:UCell#B=X:Y:Z’ is configured. In this case, soft buffer area sizes of ‘TOTAL_SOFT_SIZE*X/(X+Y+Z)’, ‘TOTAL_SOFT_SIZE*Y/(X+Y+Z)’, and ‘TOTAL_SOFT_SIZE*Z/(X+Y+Z)’ are (re)allocated to the LCell#A, the UCell#A, and the UCEll#B, respectively.

### Embodiment 22-2

A size of the total buffer area for L number of LCells and a size of the total buffer area for U number of UCells can be (re)determined according to a ratio between the number (L) of LCells and the number (U) of UCells.

Specifically, the size of the total buffer area for L number of LCells is configured by ‘TOTAL_SOFT_SIZE*L/(L+U)’ and the size of the total buffer area for U number of UCells is configured by ‘TOTAL_SOFT_SIZE*U/(L+U)’. Subsequently, if the ‘TOTAL_SOFT_SIZE*L/(L+U)’ is divided again by the number of LCells, it may be able to (re)allocate a soft buffer area with the same size to each LCell. Or, the ‘TOTAL_SOFT_SIZE*L/(L+U)’ can be divided again in proportion to MAX_DLPC of LCell. If the ‘TOTAL_SOFT_SIZE*U/(L+U)’ is divided again by the number of UCells, it may be able to (re)allocate a soft buffer area with the same size to each UCell, Or, the ‘TOTAL_SOFT_SIZE*U/(L+U)’ can be divided again in proportion to MAX_DLPC or MAX RRP size of UCell.

### Embodiment 22-3

A size of the total buffer area for L number of LCells and a size of the total buffer area for U number of UCells can be (re)determined by combining a predefined/signaled ratio (embodiment 22-1) between SFSIZE_TOTAL_LCELL and SFSIZE_TOTAL_UCELL with a ratio (embodiment 22-2) between the number (L) of LCElls and the number (U) of UCells.

Specifically, if ‘SFSIZE_TOTAL_LCELL:SFSIZE_TOTAL_UCELL=M: N’ is signaled, the size of the total soft buffer area of the L number of LCells becomes ‘TOTAL_SOFT_SIZE*M*L/(M*L+N*U)’ and the size of the total soft buffer area of the U number of UCells becomes ‘TOTAL_SOFT_SIZE*N*U/(M*L+N*U)’. Subsequently, if the ‘TOTAL_SOFT_SIZE*M*L/(M*L+N*U)’ is divided again by the number of LCells, it may be able to (re)allocate a soft buffer area with the same size to each LCell. Or, the ‘TOTAL_SOFT_SIZE*M*L/(M*L+N*U)’ can be divided again in proportion to MAX_DLPC of LCell. If the ‘TOTAL_SOFT_SIZE*N*U/(M*L+N*U)’ is divided again by the number of UCells, it may be able to (re)allocate a soft buffer area with the same size to each UCell. Or, the ‘TOTAL_SOFT_SIZE*N*U/(M*L+N*U)’ can be divided again in proportion to MAX_DLPC or MAX RRP size of UCell.

### Embodiment 22-4

A size of a soft buffer area of a cell can be (re)determined in proportion to MAX_DLPC of the cell. The present embodiment can be configured to be applied only when a CG#W is configured by a combination of LCell and UCell.

As an example, a size of a soft buffer area proportional to MAX_DLPC of a cell is (re)allocated to the cell. Assume that a CG#W includes two LCells (LCell#A and LCell#B) and one UCell (UCell#A) and the LCell #A, the LCell#B, and the UCell#A have 10, 7, and 4 MAX_DLPCs, respectively. In this case, soft buffer area sizes of ‘TOTAL_SOFT_SIZE*10/(10+7+4)’, ‘TOTAL_SOFT_SIZE*7/(10+7+4)’, and ‘TOTAL_SOFT_SIZE*4/(10+7+4)’ are (re)allocated to the LCell #A, the LCell#B, and the UCell#A, respectively.

According to the present embodiment, the size of the total soft buffer area for the L number of LCells (TOTAL_SOFT_SIZE*SUM_MXDP_L/(SUM_MXDP_L+SUM_MXDP_U)) and the size of the total soft buffer area for the U number of UCells (TOTAL_SOFT_SIZE*SUM_MXDP_U/(SUM_MXDP_L+SUM_MXDP_U)) can be (re)determined according to a ratio between the sum of MAX_DLPC values of the L number of LCells (hereinafter, ‘SUM_MXDP_L’) and the sum of MAX_DLPC values of the U number of UCells (hereinafter, ‘SUM_MXDP_U’).

Meanwhile, if the ‘TOTAL_SOFT_SIZE*SUM_MXDP_L/(SUM_MXDP_L+SUM_MXDP U)’ is divided again by the number of LCells, it may be able to (re)allocate a soft buffer area with the same size to each LCell. Or, the ‘TOTAL_SOFT_SIZE*SUM_MXDP_L/(SUM_MXDP_L+SUM_MXDP_U)’ can be divided again in proportion to MAX_DLPC of LCell. The ‘TOTAL_SOFT_SIZE*SUM_MXDP_U/(SUM_MXDP_L+SUM_MXDP_U)’ can be divided again in proportion to MAX_DLPC or MAX RRP size of UCell. Or, if the ‘TOTAL_SOFT_SIZE*SUM_MXDP_U/(SUM_MXDP_L+SUM_MXDP_U)’ is divided again by the number of UCells, it may be able to (re)allocate a soft buffer area with the same size to each UCell.

### Embodiment 22-5

In one of the aforementioned embodiments 22-1 to 22-4, if a size of the total soft buffer area for L number of LCells (SFSIZE_TOTAL_LCELL) is divided again by the number of LCells, it may be able to (re)allocate a soft buffer area with the same size to each LCell. On the contrary, a size of the total soft buffer area for U number of UCells (SFSIZE_TOTAL_UCELL) can be divided again in proportion to MAX_DLPC or MAX RRP size of an UCell.

Specifically, assume that a CG#W includes two LCells (LCell#A and LCell#B) and two UCells (UCell#A and UCell#B), and the LCell#A, the LCell#B, the UCell#A, and the UCell#B have 10, 7, 4, and 2 MAX_DLPCs, respectively. In this case, soft buffer area sizes of ‘SFSIZE_TOTAL_LCELL/2’ and ‘SFSIZE_TOTAL_LCELL/2’ are (re)allocated to the LCell#A and the LCell#B, respectively. And, soft buffer area sizes of ‘SFSIZE_TOTAL_UCELL*4/(4+2)’ and ‘SF SIZE_TOTAL_UCELL*2/(4+2)’ are (re)allocated to the UCell#A and the UCell#B, respectively.

### Embodiment 22-6

In order to efficiently use a soft buffer in aperiodic/discontinuous RRP of UCell, it may be able to configure a plurality of UCells to share a soft buffer area.

As an example, assume that a CG#W includes one LCell (LCell#A) and four UCells (UCell#A, UCell#B, UCell#C, and UCell#D), the UCell#A and the UCell#B are configured to share a soft buffer area, and the UCell#C and the UCell#D are configured to share a soft buffer area.

For example, a representative MAX_DLPC of the UCell#A and the UCell#B configured to share a soft buffer area (hereinafter, ‘REFER_MXDLPC_AB’) can be configured by ‘MIN{(MAX_DLPC of UCell#A +MAX_DLPC of UCell#B), 8}’, ‘MIN{MAX(MAX_DLPC of UCell#A, MAX_DLPC of UCell#B), 8}’, ‘MIN{MIN(MAX_DLPC of UCell#A, MAX_DLPC of UCell#B), 8}’, or a predefined/signaled value (e.g., 8). And, a representative MAX_DLPC of the UCell#C and the UCell#D configured to share a soft buffer area (hereinafter, ‘REFER_MXDLPC_CD’) can be deducted by the same method.

And, in the aspect of a UE, a plurality of cells can be configured to share a soft buffer area only when the total soft buffer areas of a plurality of the cells are fully used. A plurality of the cells can be configured to share a soft buffer area only when the remaining areas except a certain soft buffer area are fully used.

If the total soft buffer area of the UE or the remaining areas except the certain soft buffer area are not fully used, it may be able to configure a soft buffer area not in use to be used without being shared.

The UCell#A and the UCell#B can divide a soft buffer area shared by the UCell#A and the UCell#B by a representative MAX_DLPC. Although the soft buffer area is divided by the representative MAX_DLPC of the UCell#A and the UCell#B, MAX_DLPC values of individual cells can be configure to be greater or less than the representative MAX_DLPC. And, the individual cells may be able to manage HARQ operation/HARQ process/index according to the MAX_DLPCs of the individual cells.

Ucells configured to share a soft buffer area can be considered as one virtual UCell/LCell or predefined/signaled number of virtual UCells/LCells. Assume that a CG#W includes one LCell (LCell#A) and four UCells (UCell#A, UCell#B, Ucell#C, and UCell#D), the UCell#A and the UCell#B are configured to share a soft buffer area, and the UCell#C and the UCell#D are configured to share a soft buffer area. In this case, the CG#W can be considered as a CG including one LCell and two UCells. The CG#W is considered as a CG including the LCell#A, a UCell of REFER_MXDLPC_AB, and a UCell of REFER_MXDLPC_BC and the aforementioned embodiments (e.g., embodiments 22-1 to 22-5) can be applied to the CG#W.

Among cells constructing the CG#W, the present embodiment can be applied to a case that LCell and UCell share a soft buffer area, a case that a plurality of LCells share a soft buffer area, and a case that all cells constructing the CG#W share a soft buffer area.

When a soft buffer area shared by a plurality of cells is full, if there exists a data to be additionally stored, whether to store the additional data can be determined according to a predefined priority rule.

The priority rules described in the following can be configured to be applied only when predefined/signaled UCells share a soft buffer area. And, the priority rules can also be configured to be applied only when the total soft buffer area or a specific soft buffer area of a UE is fully used.

As an example, assume that a soft buffer area is shared by LCell#0, UCell#0, and UCell#1 and the soft buffer area is filled with received soft channel bits of a DL HARQ process#0 of the LCell#0 and/or a DL HARQ process#1 of the UCell#1.

(i) If it is necessary for a UE to additionally store received soft channel bits according to the DL HARQ process#1 of the LCell#0 in a (specific) soft buffer area, the UE can store the received soft channel bits according to the DL HARQ process#1 of the LCell#0 by dropping the received soft channel bits according to the DL HARQ process#1 of the UCell#1. This can be interpreted as the LCell has priority higher than that of UCell in terms of occupying a soft buffer area.

(ii) If it is necessary for a UE to additionally store received soft channel bits according to the DL HARQ process#1 of the UCell#0, it is able to configure the UE to store the received soft channel bits according to the DL HARQ process#1 of the UCell#0 by dropping the received soft channel bits according to the DL HARQ process#1 of the UCell#1. This can be interpreted as a cell having a relatively lower SERVCELLINDEX has higher priority in terms of occupying a shared soft buffer area among cells of the same type.

(iii) If it is necessary for a UE to additionally store received soft channel bits according to the DL HARQ process#0 of the UCell#1, it is able to configure the UE to store the received soft channel bits according to the DL HARQ process#0 of the UCell#0 by dropping the received soft channel bits according to the DL HARQ process#1 of the UCell#1. This can be interpreted as a cell having a relatively lower DL HARQ process index has higher priority in terms of occupying a shared soft buffer area among cells of the same type.

(iv) As a different example, priority can be defined based on at least one of a rule that LCell has priority lower than priority of UCell, a rule that a cell including a relatively higher SERVCELLINDEX has higher priority among cells of the same type, a rule that a cell including a relatively higher DL HARQ process index has higher priority among cells of the same type, a rule that a cell firstly or most recently stored/updated/aggregated a received soft channel bit or a received soft channel bit according to a DL HARQ process of the cell has higher priority (irrespective of a cell type (or in case of the same cell type)), when a timer is set to individual cells or every DL HARQ process of the cells, a rule that a cell of which a value of the timer is biggest or smallest has higher priority or a DL HARQ process of the cell has higher priority (irrespective of a cell type (or in case of the same cell type)), a rule that priority is determined based on an order of SERVCELLINDEX (irrespective of a cell type (or in case of the same cell type)), and a rule that priority is determined based on an order of DL HARQ process index (irrespective of a cell type (or in case of the same cell type)).

### Embodiment 22-7

A size of a soft buffer area of a cell can be (re)determined in proportion to MAX RRP size of the cell. The present embodiment can be configured to be applied only when a CG#W is configured by a combination of LCell and UCell.

As an example, MAX RRP size of LCell can be configured by a predefined/signaled value (e.g., 10). Specifically, assume that the CG#W includes one LCell (LCell#A) and two UCells (Ucell#A and UCell#B), MAX RRP size of the LCell#A is configured by 10, and the UCell#A and the UCell#B have 4 and 5 MAX RRP sizes, respectively. In this case, soft buffer area sizes of ‘TOTAL_SOFT_SIZE*10/(10+4+5)’, ‘TOTAL_SOFT_SIZE*4/(10+4+5)’, and ‘TOTAL_SOFT_SIZE*5/(10+4+5)’ can be (re)allocated to the LCell#A, the UCell#A, and the UCell#B, respectively.

This can be interpreted as a size of the total soft buffer area for L number of LCells (TOTAL_SOFT_SIZE*SUM_MXRRP_L/(SUM_MXRRP_L+SUM_MXRRP_U)) and a size of the total soft buffer area for U number of UCells (TOTAL_SOFT_SIZE*SUM_MXRRP_U/(SUM_MXRRP_L+SUM_MXRRP_U)) are determined according to a ratio between the sum of MAX RRP sizes of the L number of LCells (hereinafter, ‘SUM_MXRRP_L’) and the sum of MAX RRP sizes of the U number of UCells (hereinafter, ‘SUM_MXRRP_U’).

### Embodiment 23

Since UCell performs communication according to aperiodic/discontinuous RRP, a soft buffer area of the UCell is not used all the time. Hence, it may be able to configure a plurality of UCells to share the soft buffer area. By doing so, it is able to efficiently (re)utilize the soft buffer area of the UCell and secure a soft buffer area equal to or greater than a prescribed size for LCell.

Due to a restriction on an RRP size capable of utilizing RRP as much as possible or the RRP size capable of occupying RRP as big as possible, UCell-based DL data transmission can be performed with a relatively big resource size (e.g., RB size, bandwidth). In the following, methods for an eNB/UE to flexibly and efficiently divide/manage soft buffers are proposed in relation to UCell.

A soft buffer RM operation operated by an eNB at the time of transmitting DL data is referred to as ‘TX_SBRM’ (refer to Table 10). When a UE fails to receive DL data, an RM-based buffering operation, which is performed at the time of storing the DL data, is referred to as ‘RX_SBRM’ (refer to Table 9).

According to the present embodiment, Kc value (refer to Table 10) of UCell used for the TX_SBRM can be signaled irrespective of LCell. For example, Kc value of the UCell can be signaled in a manner of being different from Kc value of LCell to configure a size of a soft buffer area of the UCell to be relatively smaller. The Kc value for the UCell can be independently configured according to a UE category, a CG, or UCell reported by a UE. Or, a predefined (signaled) Kc value can be commonly applied to a part of the UE category, the CG or the UCell. And, the Kc value for the UCell can be configured to be relatively bigger or smaller than the Kc value for the LCell. And, as shown in Tables 10 and 11, the Kc value for the Lcell can be defined by a fixed value. In this case, N_{IR} and N_{cb} for the UCell (refer to Table 10) can be configured to be different from those of the LCell. As a different example, (if the entire CA is configured by a combination of UCell and LCell), it may be able to signal not only the Kc value for the UCell used for the TX_SBRM but also the Kc value for the LCell used for the TX_SBRM. Meanwhile, the Kc value for PCell (i.e., LCell) can be configured to be fixed by a value shown in Tables 10 and 11 as an exceptional case.

The Kc value for the LCell can be independently configured according to a UE category, a CG, or LCell reported by a UE. Or, a predefined (signaled) Kc value can be commonly applied to a part of the UE category, the CG; or the LCell. And, the Kc value can be independently or differently configured according to the total number of cells configured by CA or a type of cells belonging to a CG For example, if a CG#A is configured by LCells only and a CG#B is configured by UCells only, as shown in Tables 10 and 11, a Kc value for the CG#A used for the TX_SBRM can be configured by a fixed value. A Kc value for the CG#B used for the TX_SBRM can be configured by a predefined/signaled Kc value. And, a Kc value for UCell used for the TX_SBRM can be configured by the number (N^{DL}ceifl of DL cells (configured by CA), the number of UCells, or the number of LCells.

### Embodiment 24

If the aforementioned embodiment 23 is applied, a value of the number of DL cells (N^{DL}cell) can be configured(/assumed) by a value deducted by detail embodiments described in the following when the RX_SBRM is performed. A Kc value applied at the time of performing the TX_SBRM is referred to as ‘K_VAL’. The present embodiment can be configured to be restrictively applied only when RX_SBRM is performed on UCell and/or LCell. For example, a Kc value of a Tx end and a Kc value of an Rx end can be differently configured.

### Embodiment 24-1

It may be able to perform the RX_SBRM via a value deducted from MAX(K_VAL, N^{DL}_{cell}) or MIN(K_VAL,N^{DL}_{cell}). If K_VAL is signaled, it may define a rule of having a value greater or less than the N^{DL}_{Cell}.

### Embodiment 24-2

It may be able to perform the RX_SBRM via a value deducted from MAX(Qₗᵢₘᵢₜ, K_VAL) or MIN(Qₗᵢₘᵢₜ, K_VAL). When a UE fails to receive CB of PDSCH TB related to a specific cell, a predefined (signaled) Qₗᵢₘᵢₜ can be interpreted as a parameter influencing on a size or an upper limit/lowest limit of received soft channel bits for the CB stored in a soft buffer of the UE. The Qₗᵢₘᵢₜ can be independently configured according to a UE category, a CG, or a cell type. Or, a pre-signaled Qₗᵢₘᵢₜ value can be applied to a part of the UE category, the CG, a cell/cell type.

### Embodiment 24-3

It may be able to perform the RX_SBRM via a value deducted from MAX(Rₗᵢₘᵢₜ, N^{DL}_{Cell}) or MIN(Rₗᵢₘᵢₜ, N^{DL}_{Cell}). For example, when a UE fails to receive CB of PDSCH TB of a specific cell, a predefined/signaled Rₗᵢₘᵢₜ can be interpreted as a parameter influencing on a size or an upper limit/lowest limit of received soft channel bits for the CB stored in a soft buffer of the UE. The Rₗᵢₘᵢₜ can be independently configured according to a UE category, a CG or a cell type. Or, the Rₗᵢₘᵢₜ value for a part of the UE category, the CG, or a cell/cell type can be commonly applied.

### Embodiment 25

For clarity, the number of cell(s) configured by massive CA scheme is referred to as ‘P’. For example, P number of cell(s) can be configured by Lcell(s) only, UCell(s) only, or a combination of LCell(s) and UCell(s). Embodiments described in the following can be configured to be applied only when CA is performed on (DL) cells greater than the predefined number of cells or when a massive CA mode is configured.

According to one embodiment, a Kc parameter can be configured as a P value. If ‘(Kc<P)’ is satisfied, a soft buffer size (i.e., ‘N_{IR}’, ‘N_{cb}’) for TB/CB transmission is configured by a value smaller than N_{IR} or N_{cb} which is calculated by a Kc value in 3GPP LTE standard. And, it is able to be interpreted as a practically applied code rate is relatively higher than an MCR value applied to TB or CB.

Unlikely, it may be able to define a rule that the present embodiment is restrictively applied only when (KC≧P) is satisfied or a rule that the present embodiment is restrictively applied only when a practically applied code rate is not higher than an MCR value applied to a predefined/signaled TB or CB. Legacy parameters K_{C}, N_{IR}, and N_{cb} are defined in Tables 10 and 11.

### Embodiment 26

It may be able to additionally signal a Kc value according to a cell. Yet, as an exceptional case, a Kc value for a PCell is defined by a fixed value (refer to Table 10) defined in legacy 3GPP standard and Kc values for SCell(s) can be signaled only.

And, the additionally signaled Kc value can be independent from each other according to a UE category. Or, the signaled Kc value can be commonly applied to a partial UE category and a cell.

### Embodiment 27

According to one embodiment of the present invention, a Kc value is fixed by a value defined in Tables 10 and 11. Yet, it may be able to obtain n_{CB} value by putting a predefined/signaled value (hereinafter, ‘BF_VAL’) rather than P in N^{DL}_{Cell} parameter. For example, the BF VAL can be configured by 5 or Kc. The BF_VAL can be independent from each other according to a UE category or a cell. Or, a signaled BF_VAL can be commonly applied to a partial UE category or a cell. Or, the BF_VAL can be independent from ‘maximum number of supported cell(s)’ reported by a UE.

Specifically, assume that the BF_VAL is configured by 5 in a situation that 10 FDD cells are configured by CA (i.e., P=10). In this case, for example, although 10 FDD cells are configured by CA, it may be able to configure a soft buffer area size equal to or smaller than a soft buffer area size configured for a case that maximum 5 FDD cells are configured by CA. And, it may be able to identically maintain a minimum stored soft channel bit(s) size which is stored when an error occurs in receiving CB or TB.

In this case, a UE divides a soft buffer area of the UE by N′_{soft}/5 and stores/shares reception error data for 10 FDD cell(s) in 5 soft buffer areas. This can be comprehended as the minimum stored soft channel bit(s) size, which is stored when an error occurs in receiving CB or TB, is identically configured among the 10 FDD cell(s).

Unlikely, the UE may divide the soft buffer area of the UE by N′_{soft}/5 and may be then able to store (share) reception error data for Q number (e.g., 2) of cell(s), which are mapped (allocated) to a specific divided soft buffer area (i.e., N′_{soft}/5), in the specific soft buffer area.

A type of cell(s) or the number of cell(s) mapped/allocated to a divided soft buffer area (i.e., N′_{soft}/5) can be defined/signaled in advance.

For example, when two cells (cell#A and cell#B) share a divided specific soft buffer area (i.e., N′_{soft}/5), the soft buffer area can be divided again based on a representative MDL HARQ value (hereinafter, ‘REF MDL’), a representative C value (hereinafter, ‘REF_C’), or a representative K_{MIMO} value (hereinafter, ‘REF_KMI’) of the cell#A and the cell#B. The REF_MDL value can be configured by ‘MIN{MAX(MDL_HARQ of cell#A, MDL_HARQ of cell#B), 8}’, MIN{(MDL_HARQ of cell#A +MDL_HARQ of cell#B), 8}’, ‘MIN{MIN(MDL_HARQ of cell#A, MDL_HARQ of cell#B), 8}, or a predefined/signaled value (e.g., 8). The REF_C value can be configured by ‘MAX(C of cell#A, C of cell#B)’, ‘MIN(C of cell#A, C of cell#B)’, or a predefined/signaled value. The REF_KMI value can be configured by MAX(K_{MINO} of cell#A, K_{MINO} of cell#B)'; ‘MIN(K_{MINO} of cell#A, K_{MINO} of cell#B), or a predefined/signaled value (e.g., 2).

The specific soft buffer area shared by the cell#A and the cell#B can be divided again by N′soft/(5*REF_MDL*REF_C*REF_KMI) or N′soft/(5*REF_MDL).

In the foregoing description, the soft buffer area sharing operation can be implemented by configuring the BF_VAL to be smaller than N^{DL}_{cell}. The soft buffer area sharing operation can be configured to be restrictively applied only when the N^{DL}_{cell} is equal to or greater than a predefined/signaled value.

Unlikely, when CA is performed on 10 FDD cells, it may be able to obtain n_{SB} value by putting a predefined/signaled value (hereinafter, ‘BF_ML’) in Mₗᵢₘᵢₜ parameter while putting P=10 in the N^{DL}_{cell} parameter. The Mₗᵢₘᵢₜ can be independent according to a UE category or a cell. Or, the Mₗᵢₘᵢₜ set/signaled to a partial UE category or a cell can be commonly applied. Or, the Mₗᵢₘᵢₜ can be independent from ‘maximum number of supported cell(s)’ reported by a UE.

Specifically, although CA is performed on 10 FDD cells, the Mₗᵢₘᵢₜ can be defined by 4. By doing so, it may be able to maintain a soft buffer area size equal to or smaller than a soft buffer area size configured for a case that maximum 5 FDD cells are configured by CA. And, it may be able to maintain a minimum stored soft channel bit(s) size, which is stored when an error occurs in receiving CB or TB, equal to or smaller than a minimum stored soft channel bit(s) size configured for a case that maximum 5 FDD cells are configured by CA. Meanwhile, Kc value may correspond to a fixed value shown in Tables 10 and 11.

### Embodiment 28

In the following, methods (for a UE) to efficiently manage a soft buffer are proposed (to support (increasing DL and/or UL) data demand) when a plurality of cell(s) are configured by CA technique. In this case, for example, it may be able to define a rule that the proposed methods are restrictively applied only when the number of (DL) cells greater than the predefined/signaled number of cells are configured by the CA technique or when a massive CA mode is configured only. And, for example, it may be able to define a rule that the methods proposed in the following are restrictively applied to UCells (or, LCells, or UCells/LCells) or a CG(s) configured by UCell(s) only (or, a CG(s) configured by LCell(s) only, or a CG(s) configured by UCell(s)/LCell(s) only). For clarity, assume that the total number of cell(s) set to a UE corresponds to N and the number of reference cell(s) for soft buffer division corresponds to K. In this case, assume that the N is equal to or greater than the K.

When a soft buffer is allocated to a specific cell#X (i.e., when minimum stored soft buffer bit(s) size of the cell#X is determined), it may be able to determine a soft buffer size of a HARQ process or a minimum stored soft channel bit(s) size on the basis of MDL_HARQ value (refer to Table 9) in a state that the total soft buffer is divided under an assumption of K number of cells.

For example, nSB value for the cell#X can be obtained by putting K, M_{DL}_{_}_{HARQ} of the cell#X, K_{MIMO} of the cell#X, and C of the cell#X in N^{DL}_{Cell}, M_{DL}_{_}_{HARQ}, K_{MIMO}, and C parameters, respectively. In this case, for example, nSB value for the remaining cell(s) can also be calculated using the same method.

### Embodiment 29

It may be able to define a rule that a soft buffer is divided on the basis of the specific K number of cell(s) among the N number of cell(s) (or, minimum stored soft channel bit(s) size is determined) and each of the remaining (N−K) number of cell(s) determines (signals) a cell to share a soft buffer among the K number of reference cell(s).

For example, if a cell#X shares a soft buffer with a reference cell#Y, a minimum stored soft channel bit(s) size which is divided on the basis of M_{DL}_{_}_{HARQ} of the cell#Y and a soft buffer size (S_C) according to a HARQ process are applied to the cell#X.

For example, assume that one of the K number of reference cell(s), which are used for dividing a soft buffer, determining a soft buffer size according to a cell/HARQ process, or determining a minimum stored soft channel bit(s), corresponds to a cell#W and assume that the cell#W and a cell#Q share a soft buffer. An n_{SB} value for the cell#W can be obtained by putting K, M_{DL}_{_}_{HARQ} of the cell#W, K_{MIMO} of the cell#W, and C of the cell#W in K, M_{DL}_{_}_{HARQ} of the cell#W, K_{MIMO} of the cell#W, C of the cell#W parameters in Table 9, respectively. An n_{SB} value related to the cell#Q can be obtained by putting K, M_{DL}_{_}_{HARQ} of the cell#W, K_{MIMO} of the cell#W (or cell#Q), and C of the cell#W (or cell#Q) in N^{DL}_{Cell}, M_{DL}_{_}_{HARQ}, K_{MIMO}, and C parameters in Table 9, respectively.

If the cell#Y is in a non-MIMO mode, assume that the S_C corresponds to a minimum stored soft channel bit size for TB/CB or a soft buffer size corresponding to a single HARQ process. If the cell#Y is in a MIMO mode, assume that the S_C corresponds to a minimum stored soft channel bit size for one of a plurality of TB/CB or a soft buffer size corresponding to a single HARQ process. If ‘(CELL#X, CELL#Y)=(MIMO MODE, NON-MIMO MODE)’ is satisfied, a size of ‘(S_C/2)’ can be applied to a single TB/CB in a single HARQ process of the cell#X. If ‘(CELL#X, CELL#Y)=(NON-MIMO MODE, MIMO MODE)’ is satisfied, a size of ‘(S_C*2)’ can be applied to a TB/CB corresponding to a single HARQ process of the cell#X. The MIMO mode may correspond to a DL data reception mode based on TM 3/4/8/9/10.

As a different example, a soft buffer shared by the cell#X/cell#Y can be divided by a combination/relation of a MDL_HARQ value of the cell#X/cell#Y, e.g., ‘MIN{MAX(MDL_HARQ of cell#X, MDL_HARQ of cell#Y), 8}’, ‘MIN{(MDL_HARQ of cell#X+MDL_HARQ of cell#Y), 8}’′, ‘MIN{MIN(MDL_HARQ of cell#X, MDL_HARQ of cell#Y), 8}’, or a predefined/signaled value (e.g., 8). In this case, the determined minimum stored soft channel bit(s) size or the soft buffer size (S_C) according to a HARQ process can be identically applied to the cell#X/cell#Y. Assume that a cell#T corresponding to one of the K number of reference cell(s), which are used for dividing a soft buffer, determining a soft buffer size according to a cell/HARQ process, or determining a minimum stored soft channel bit(s), shares a soft buffer with a cell#U. Assume that M_{REF}_{_}_{DLHARQ} is obtained by a combination/relation of M_{DL}_{_}_{HARQ} values of the cell#T/cell#U. In this case, an n_{SB} value for the cell#T can be obtained by putting K, M_{REF}_{_}_{DLHARQ}, K_{MIMO} of the cell#T, and C of the cell#T in M_{DL}_{_}_{HARQ}, K_{MIMO}, and C parameters in Table 9, respectively. An n_{SB} value related to the cell#U can be obtained by putting K, M_{REF}_{_}_{DLHARQ}, K_{MIMO} of the cell#T (or cell#U), and C of the cell#T (or cell#U) in N^{DL}_{Cell}, M_{DL}_{_}_{HARQ}, K_{MIMO}, and C parameters in Table 9, respectively.

Meanwhile, assume that the S_C corresponds to a TB/CB-related minimum stored soft channel bit size or a soft buffer size according to a HARQ process considering the M_{DL}_{_}_{HARQ} only without considering the MIMO mode. In case of a cell in a non-MIMO mode, a size of the S_C is applied to TB/CB corresponding to a single HARQ process. In case of a cell in a MIMO mode, a size of SC/2 is applied to TB/CB in a single HARQ process.

### Embodiment 30

It may be able to determine a soft buffer size according to a HARQ process/minimum stored soft channel bit(s) size by assuming that K number of cell(s) different from number of cells is configured in massive CA situation and all cell(s) are configured by a predefined/signaled Mₗᵢₘᵢₜ value (hereinafter, ‘M_RES’), M_{DL}_{_}_{HARQ} value, K_{MIMO} value, or C value.

For example, a soft buffer size according to a HARQ process/minimum stored soft channel bit(s) size (S_C) of N number of cell(s) is identically allocated. When the above rule is applied, if it is assumed that a predefined/signaled M_{DL}_{_}_{HARQ} value (or Mₗᵢₘᵢₜ value) corresponds to M_{F}_{_}_{DLHARQ} (or M_{FF}_{_}_{LIMIT}), n_{SB} for a cell#X can be obtained by putting K and M_{F}_{_}_{DLHARQ} (, M_{F}_{_}_{LIMIT}) in N^{DL}_{Cell} and M_{DL}_{_}_{HARQ} (, Mₗᵢₘᵢₜ) parameters described in Table 9, respectively. n_{SB} for the remaining cell(s) can also be calculated by the same method.

Meanwhile, assume that the S_C corresponds to a minimum stored soft channel bit size/soft buffer size according to a HARQ process for TB/CB, which is determined in consideration of the M_{DL}_{_}_{HARQ} value only without considering MIMO mode. In case of a cell in non-MIMO mode, a size of S_C is applied to TB/CB corresponding to a single HARQ process. In case of a cell in MIMO mode, a size of SC/2 is applied to a TB/CB in a single HARQ process.

### Embodiment 31

First of all, in a state that the total soft buffer is divided by assuming K number of cell(s) for specific L number of cell(s) (in this case, for example, such a relation as ‘(L<K)’ is configured), a soft buffer size according to a HARQ process (or minimum stored soft channel bit(s) size) is allocated/determined on the basis of M_{DL}_{_}_{HARQ} of each cell#X. Secondly, in a state that the remaining soft buffers are divided by assuming (N−L) number of cell(s) for the remaining (N−L) number of cell(s), a soft buffer size according to a HARQ process (or minimum stored soft channel bit(s) size) is allocated/determined under an assumption that all cell(s) correspond to a predefined/signaled M_{DL}_{_}_{HARQ} value (i.e., “M_RES”) (or Mₗᵢₘᵢₜ value) equal to or smaller than an actual size. As a different example, in a state that the total soft buffers are divided by assuming N (or G (in this case, such a relation as ‘(G=N−L)’ or ‘(N>G>K)’ is configured) number of cell(s) for the remaining (N−L) number of cell(s), a soft buffer size according to a HARQ process (or minimum stored soft channel bit(s) size) is allocated/determined on the basis of M_{DL}_{_}_{HARQ} value of each cell#X or a predefined/signaled M_{DL}_{_}_{HARQ} value (i.e., “M_RES”) (or Mₗᵢₘᵢₜ value) smaller than the M_{DL}_{_}_{HARQ} value of each cell#X.

The M_RES value/Mₗᵢₘᵢₜ value can be independently (differently) (or, identically between cells (groups) configured/signaled according to a cell (group) (or cell type (e.g., LCell, UCell).

And, the M_RES value/Mₗᵢₘᵢₜ value can be independently configured in MIMO mode and non-MIMO mode. Or, the M_RES value/Mₗᵢₘᵢₜ value can be identically configured/signaled in the MIMO mode and the non-MIMO mode. For example, M_RES value or Mₗᵢₘᵢₜ value of the non-MIMO mode can be configured by M_RES value*2 of the MIMO mode or Mₗᵢₘᵢₜ valu 2 of the MIMO mode.

### Embodiment 32

In all or a part of the aforementioned embodiments (e.g., embodiments 28 and/or 29, embodiments 30 and/or 31), if ‘Z’ number of cell(s) equal to or less than ‘K’ number of reference cell(s) (for dividing a soft buffer) are configured by CA, a UE can divide the total soft buffer of the UE according to a legacy scheme (e.g., Table 9 and/or Table 10 and/or Table 11) (e.g., ‘total soft buffer size/Z’). In this case, for example, the number of reference cells may become a reference for dividing a soft buffer.

On the contrary, if number of cells greater than the ‘K’ number of reference cell(s) (for dividing a soft buffer) is configured by CA, a UE may operate according to all or a part of the aforementioned embodiments (e.g., embodiments 28 and/or 29, embodiments 30 and/or 31).

In this case, the ‘K’ corresponding to the number of reference cells (for dividing a soft buffer) can be independently or differently configured according to at least one of a peak data rate capable of being supported by a UE, buffer capability, and a UE category. A UE can report the peak data rate capable of being supported by the UE, the buffer capability, and the UE category to a base station via a predefined channel (/signal).

Or, the base station may directly signal/set the ‘K’ corresponding to the number of reference cells (for dividing a soft buffer) to the UE. In this case, for example, the ‘K’ corresponding to the number of reference cells can be determined based on the peak data rate capable of being supported by the UE, the buffer capability, and the UE category reported by the UE.

And, for example, in the aforementioned embodiments (e.g., embodiments 28 and/or 29, embodiments 30 and/or 31), the Mᵢᵢₘᵢₜ value can be independently (differently) configured/signaled according to a cell. For example, the base station may configure the Mₗᵢₘᵢₜ value by 8 for LCells and configure the Mₗᵢₘᵢₜ value by 4 for UCells.

It may define a rule that the aforementioned embodiments are restrictively applied to a specific cell type (e.g., UCell or LCell) or a CG of a specific cell type only. And, the aforementioned proposed schemes can be differently/independently applied according to a cell type, a CG or a cell. It may be able to define a rule that a different/independent proposed scheme is applied according to a UE category. It may be able to define a rule that the proposed scheme are restrictively applied to a case that a massive CA mode is configured, and/or a case that cell(s) (LCell(s), UCell(s), or LCell(s)/UCell(s)) equal to or greater than the predefined (signaled) number of cells are configured (or, configured cell(s) (configured LCell(s), configured UCell(s), or configured LCell(s)/UCell(s)) equal to or greater than the predefined (signaled) number of cells are configured, and/or a case that activated cell(s) (activated LCell(s), activated UCell(s), or activated LCell(s)/UCell(s)) equal to or greater than the predefined (signaled) number of cells are configured only. In case of the opposite cases (e.g., a case that a massive CA mode is not configured, and/or a case that cell(s) (LCell(s), UCell(s), or LCell(s)/UCell(s)) less than the predefined (signaled) number of cells are configured (or, configured cell(s) (configured LCell(s), configured UCell(s), or configured LCell(s)/UCell(s)) less than the predefined (signaled) number of cells are configured, and/or a case that activated cell(s) (activated LCell(s), activated UCell(s), or activated LCell(s)/UCell(s)) less than the predefined (signaled) number of cells are configured), it may apply Table 10 and Table 11.

The examples for the proposed scheme can be included in one of methods of implementing the present invention. Hence, it is apparent that the examples can be considered as a sort of the proposed schemes. The aforementioned proposed schemes can be implemented independently or can be implemented in a combined (aggregated) form of a part of the proposed schemes.

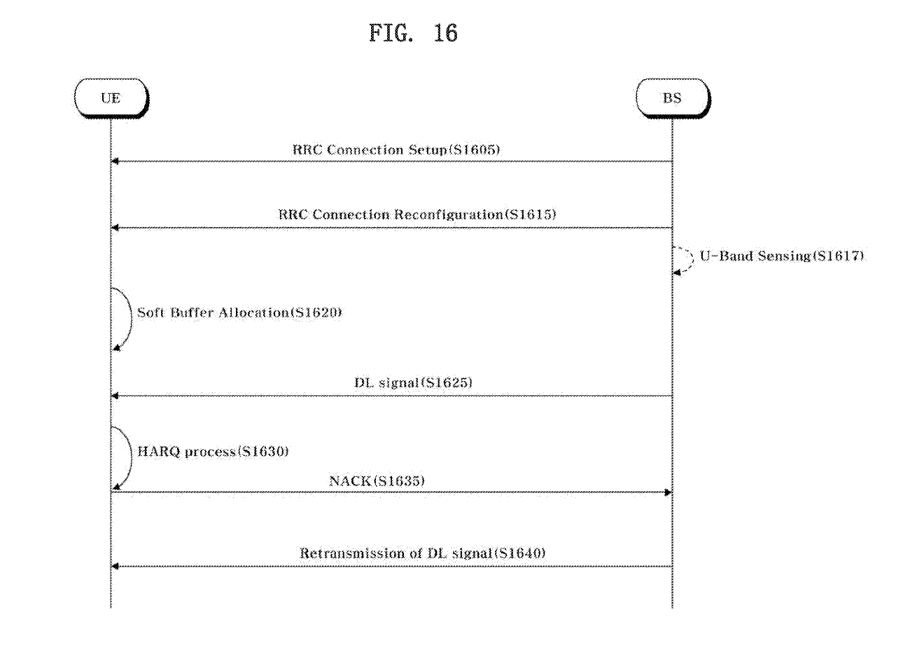

FIG. 16 is a flowchart for a method of managing a soft buffer according to one embodiment of the present invention. FIG. 16 corresponds to an example only for helping the understanding of the aforementioned embodiments. The scope of right of the present invention according to the aforementioned embodiments is not restricted by FIG. 16. Explanation on contents overlapped with the aforementioned embodiments can be omitted.

Referring to FIG. 16, a UE makes a request for RRC connection to a base station and receives an RRC connection configuration message [S1605]. RRC connection to a first cell is established according to the RRC connection configuration message. In the present specification, assume that the first cell is located on a licensed band.

Subsequently, the UE receives an RRC connection reconfiguration message from the base station [S1615]. The RRC connection reconfiguration message can include information indicating that at least one or more second cells are additionally set to the first cell. The first cell and the second cells may operate in a manner of being CA. The first cell may operate as a Pcell and the second cells may operate as a Scell. If CCS is applied, the second cells are scheduled via the first cell.

Meanwhile, at least one of the second cells may be located on an unlicensed band. For example, the second cell may correspond to a cell of an unlicensed band capable of being used within an reserved resource period (RRP) reserved via carrier sensing.

According to one embodiment, the base station can secure an RRP by performing carrier sensing [S1617]. According to a different embodiment, the UE or a third node performs carrier sensing on an unlicensed band and may be then able to report a result of the carrier sensing to the base station. For clarity, although it is depicted as the carrier sensing is performed prior to the configuration of the second, by which the present invention may be non-limited. It may be able to periodically or aperiodically perform carrier sensing after the configuration of the second cell.

Meanwhile, the UE can obtain at least one parameter for allocating a soft buffer of the UE via the RRC connection configuration message [S1605], the RRC connection reconfiguration message [S1615], and/or a separate RRC signaling message.

For example, the at least one parameter can include at least one of the number of virtual cells, which are configured in a manner of being different from the number (N^{DL}_{Cell}) of a plurality of cells, the number (M_{DL}_{_}_{HARQ}) of cell-specifically configured maximum hybrid automatic repeat request (HARQ) processes, a limit value (Mₗᵢₘᵢₜ), which is cell-specifically configured for the number (M_{DL}_{_}_{HARQ}) of maximum DL hybrid automatic repeat request (HARQ) processes, and a cell-specific parameter (K_{MIMO}) supporting multiple transport blocks (TBs) in multiple input multiple output (MIMO) transmission mode, by which the present invention may be non-limited.

The UE allocates the soft buffer of the UE to a plurality of cells using at least one parameter obtained from the base station [S1620]. The soft buffer can be unequally divided based on the received at least one parameter. And, at least one of partitions of the unequally divided soft buffer can be shared by at least two cells among a plurality of the cells.

For example, the number of partitions of the unequally divided soft buffer can be configured to be different from the number of a plurality of the cells set to the UE. And, the at least two cells sharing the partition can be determined according to whether or not the cells are positioned on an unlicensed band.

When the UE allocates the partitions of the soft buffer to a plurality of the cells, the UE can hierarchically perform division of the soft buffer for a plurality of cell groups and re-division of the soft buffer for individual cells belonging to each cell group. And, a part of the soft buffer, which is allocated to a licensed band cell group among the plurality of cell groups, can be configured to be bigger than the remaining part of the soft buffer allocated to an unlicensed band cell group. And, the re-division of the soft buffer for the individual cells can be performed based on the number of licensed band cells in a licensed band cell group among the plurality of cell groups. And, the re-division of the soft buffer for the individual cells can be performed based on at least one of the number of unlicensed band cells, a maximum value of DL hybrid automatic repeat request (HARQ) processes for each of the unlicensed band cells, and a maximum value of reserved resource period (RRP) for each of the unlicensed band cells in an unlicensed band cell group among the plurality of cell groups.

Meanwhile, a size of a partition of the unequally divided soft buffer can be configured based on at least one of the number of maximum DL hybrid automatic repeat request (HARQ) processes for each of a plurality of the cells, frequency bands at which a plurality of the cells are positioned, a maximum value of reserved resource period (RRP) in an unlicensed band cell, a maximum value of DL subframes capable of being continuously scheduled in an unlicensed band cell, and a ratio between unlicensed band cell and licensed band cell among a plurality of the cells.

The base station transmits a DL signal to the UE [S1625]. In this case, the DL signal can include PDSCH TB/CB. The PDSCH TB/CB can be transmitted in consideration of the allocation of the soft buffer of the UE.

For clarity, assume that the UE has failed in decoding at least a part of the DL signal.

The UE stores at least a part of soft channel bits, which is received in response to the decoding-failed DL signal, in the soft buffer according to a DL HARQ process [S1630] and transmits NACK to the base station [S1635].

For example, when the UE stores the soft channel bits in the soft buffer, if at least two cells compete with each other in at least one shared partition, a licensed band cell has priority higher than that of an unlicensed band cell among the at least two cells, a cell having a lower cell index has priority among the at least two cells, or a cell having a lower DL hybrid automatic repeat request (HARQ) process index has priority among the at least two cells, by which the present invention may be non-limited.

The base station retransmits a DL signal [S1640]. The UE can decode the retransmitted DL signal using the soft channel bit stored in the soft buffer.

In the foregoing description, although it is depicted as a plurality of the cells belong to the same base station for clarity, a plurality of the cells may belong to base stations or transmission points different from each other.

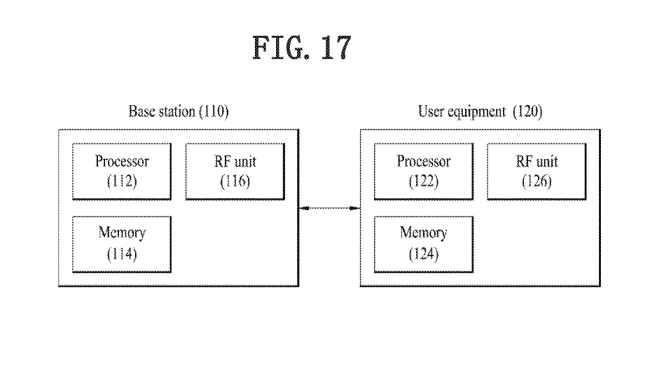

FIG. 17 illustrates a base station and a user equipment applicable to one embodiment of the present invention. The base station and the UE shown in FIG. 17 can perform methods according to the aforementioned embodiments.

If a relay is included in a wireless communication system, communication is performed between a base station and the relay in backhaul link and communication is performed between the relay and a user equipment in access link. Hence, the base station and the user equipment shown in the drawing can be replaced with the relay in accordance with a situation.

Referring to FIG. 17, a wireless communication system includes a base station (BS) 110 and a user equipment (UE) 120. The BS 110 includes a processor 112, a memory 114 and a radio frequency (RF) unit 116. The processor 112 can be configured to implement the proposed functions, processes and/or methods. The memory 114 is connected with the processor 112 and then stores various kinds of information associated with an operation of the processor 112. The memory 114 can include a soft buffer area for HARQ process. The RF unit 116 is connected with the processor 112 and transmits and/or receives a radio signal. The RF unit 116 can include a transmitter and/or a receiver. The user equipment 120 includes a processor 122, a memory 124 and a radio frequency (RF) unit 126. The processor 122 can be configured to implement the proposed functions, processes and/or methods. The memory 124 is connected with the processor 122 and then stores various kinds of information associated with an operation of the processor 122. The memory 124 can include a soft buffer area for HARQ process. The RF unit 126 is connected with the processor 122 and transmits and/or receives a radio signal. The RF unit 126 can include a transmitter and/or a receiver. The base station 110 and/or the user equipment 120 may have a single antenna or multiple antennas.

The above-described embodiments correspond to combinations of elements and features of the present invention in prescribed forms. And, the respective elements or features may be considered as selective unless they are explicitly mentioned. Each of the elements or features can be implemented in a form failing to be combined with other elements or features. Moreover, it is able to implement an embodiment of the present invention by combining elements and/or features together in part. A sequence of operations explained for each embodiment of the present invention can be modified. Some configurations or features of one embodiment can be included in another embodiment or can be substituted for corresponding configurations or features of another embodiment. And, it is apparently understandable that an embodiment is configured by combining claims failing to have relation of explicit citation in the appended claims together or can be included as new claims by amendment after filing an application.

In this disclosure, a specific operation explained as performed by a base station may be performed by an upper node of the base station in some cases. In particular, in a network constructed with a plurality of network nodes including a base station, it is apparent that various operations performed for communication with a user equipment can be performed by a base station or other networks except the base station. ‘Base station (BS)’ may be substituted with such a terminology as a fixed station, a Node B, an eNode B (eNB), an access point (AP) and the like.

Embodiments of the present invention can be implemented using various means. For instance, embodiments of the present invention can be implemented using hardware, firmware, software and/or any combinations thereof. In the implementation by hardware, a method according to each embodiment of the present invention can be implemented by at least one of ASICs (application specific integrated circuits), DSPs (digital signal processors), DSPDs (digital signal processing devices), PLDs (programmable logic devices), FPGAs (field programmable gate arrays), processor, controller, microcontroller, microprocessor and the like.

In case of the implementation by firmware or software, a method according to each embodiment of the present invention can be implemented by modules, procedures, and/or functions for performing the above-explained functions or operations. Software code is stored in a memory unit and is then drivable by a processor.

The memory unit is provided within or outside the processor to exchange data with the processor through the various means known in public.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

The embodiments of the present invention can be applied to various wireless communication systems including 3GPP LTE system.

What is claimed is:

1. A method of managing a soft buffer by a user equipment configured with a plurality of cells, the method comprising:
receiving at least one parameter for allocating the soft buffer from a base station; and
allocating the soft buffer to the plurality of cells based on the at least one parameter,
wherein the soft buffer is unequally divided based on the at least one received parameter and
wherein at least one of partitions of the unequally divided soft buffer is shared by at least two cells among the plurality of cells.

2. The method of claim 1, wherein a number of the partitions of the unequally divided soft buffer is configured in a manner of being different from the number of the plurality of cells.

3. The method of claim 1, wherein the at least two cells sharing the partition are determined according to whether or not the at least two cells are positioned at an unlicensed band.

4. The method of claim 1, wherein if the at least two cells compete with each other in the at least one shared partition, a licensed band cell has priority over an unlicensed band cell among the at least two cells, a cell of a lower cell index has priority among the at least two cells, or a cell of a lower downlink hybrid automatic repeat request (HARQ) process index has priority among the at least two cells.

5. The method of claim 1, wherein allocating the soft buffer to the plurality of cells comprises:
hierarchically performing division of the soft buffer for a plurality of cell groups and re-division of the soft buffer for individual cells in each of the plurality of cell groups.

6. The method of claim 5, wherein a part of the soft buffer allocated to a licensed band cell group is configured to be bigger than a remaining part of soft buffer allocated to an unlicensed band cell group among the plurality of cell groups.

7. The method of claim 5,
wherein in a licensed band cell group among the plurality of cell groups, the re-division of the soft buffer for the individual cells is performed based on a number of licensed band cells and
wherein in an unlicensed band cell group among the plurality of cell groups, the re-division of the soft buffer for the individual cells is performed based on at least one of a number of unlicensed band cells, a maximum value of downlink hybrid automatic repeat request (HARQ) processes for each of the unlicensed band cells, and a maximum value of a reserved resource period (RRP) for each of the unlicensed band cells.

8. The method of claim 1, wherein the at least one parameter comprises at least one of a number of virtual cells configured to be different from a number (N^{DL}_{Cell}) of the plurality of cells in dividing the soft buffer, a number (M_{DL}_{_}_{HARQ}) of cell-specifically configured maximum downlink hybrid automatic repeat request (HARQ) processes, a maximum number (Kc) of cells capable of being supported by the user equipment under a prescribed condition, a limit value (Mₗᵢₘᵢₜ), which is cell-specifically configured for the number (M_{DL}_{_}_{HARQ}) of maximum downlink HARQ processes, and a cell-specific parameter (K_{MIMO}) supporting multiple transport blocks (TBs) in multiple input multiple output (MIMO) transmission mode.

9. The method of claim 1, wherein a size of each of the partitions of the unequally divided soft buffer is configured based on at least one of a number of maximum downlink hybrid automatic repeat request (HARQ) processes for each of the plurality of cells, frequency bands at which the plurality of cells are positioned, a maximum value of an reserved resource period (RRP) in an unlicensed band cell, a maximum value of downlink subframes capable of being continuously scheduled in the unlicensed band cell, and a ratio between the unlicensed band cell and a licensed band cell among the plurality of cells.

10. A user equipment configured with a plurality of cells, comprising:
a receiver configured to receive at least one parameter for allocating a soft buffer from a base station; and
a processor configured to allocate the soft buffer to the plurality of cells based on the at least one parameter,
wherein the soft buffer is unequally divided based on the at least one received parameter and wherein at least one of partitions of the unequally divided soft buffer is shared by at least two cells among the plurality of cells.

11. The user equipment of claim 10, wherein a number of the partitions of the unequally divided soft buffer is configured in a manner of being different from the number of the plurality of cells.

12. The user equipment of claim 10, wherein the at least two cells sharing the partition are determined according to whether or not the at least two cells are positioned at an unlicensed band.

13. The user equipment of claim 10, wherein if the at least two cells compete with each other in the at least one shared partition, a licensed band cell has priority over an unlicensed band cell among the at least two cells, a cell of a lower cell index has priority among the at least two cells, or a cell of a lower downlink hybrid automatic repeat request (HARQ) process index has priority among the at least two cells.

14. The user equipment of claim 10, wherein the processor allocating the soft buffer to the plurality of cells is configured to hierarchically perform division of the soft buffer for a plurality of cell groups and re-division of the soft buffer for individual cells in each of the plurality of cell groups.

15. The user equipment of claim 14, wherein a part of the soft buffer allocated to a licensed band cell group is configured to be bigger than a remaining part of soft buffer allocated to an unlicensed band cell group among the plurality of cell groups.
